(19) United States
(12) Patent Application Publication
(10) Pub. No.: US 2008/0052083 A1
(43) Pub. Date: Feb. 28, 2008

(54) SYSTEMS AND METHODS FOR AUDIO-MARKING OF INFORMATION ITEMS FOR IDENTIFYING AND ACTIVATING LINKS TO INFORMATION OR PROCESSES RELATED TO THE MARKED ITEMS

(76) Inventors: Shaul Shalev, Savion (IL); Josef Berger, Santa Clara, CA (US)

Correspondence Address: SCHNECK & SCHNECK, P.O. BOX 2-E, SAN JOSE, CA, 95109-0005, US

(21) Appl. No.: 11/845,922

(22) Filed: Aug. 28, 2007

Related U.S. Application Data
(60) Provisional application No. 60/823,741, filed on Aug. 28, 2006.

(51) Int. Cl. G10L 19/00

(52) U.S. Cl. 704/500; 704/E19.001

(57) ABSTRACT

Systems and methods of creating and utilizing audio-marking of specific information items for pointing at the existence of Additional Information and Processes (AIPs) related to such information items and, when required, activating preset links to such specific AIPs. The invention describes processes and methods that enable authorized creation, insertion and activation of Audio-based Marking-Signals (“AMSs”) in association with streaming or playing of audio-related information files, containing the Marked Information Items (MIIs), for enabling precise identification and activation of identified accessible links to AIPs related to the MIIs. Users of the system and methods, who operate communication devices and are able to sense the AMSs, can correlate the AMS existence and type to a specific MII, and, if interested, activate links to specific MII-related AIPs, using short command messages for receiving the relevant information or activating relevant processes.

### CROSS-REFERENCE TO RELATED APPLICATION

This application claims priority from U.S. provisional application No. 60/823,741, filed Aug. 28, 2006.

### TECHNICAL FIELD

The present invention relates generally to audio and audiovisual data, and more particularly, to systems and methods for embedding information in audio and audiovisual data.

### BACKGROUND

Information presented on Two Dimensional (2D) displays of computers and communication devices enables users to view and analyze, in parallel, several visual information items. Retrieval of additional information related to a displayed information item is usually managed by utilizing one out of two main options. In the non-Web space, the links to the “additional information” are usually managed by menus. The menus enable retrieval of the required information through branching of the information-management tree leading to further detailing process while entering “branching junction” and selecting a specific branch connected to that junction.

In the Web HTML space, further detailing or links to other sources of data is managed by a “Visual-Marking” designating Hyperlinks (commonly used HyperText Markup Language—HTML) that are applied to the “Marked Displayed-Information” in the 2D displayed content. The Hyper-linked items are usually marked by different visual appearance, such as an underlined line, a different color, and in certain cases an audio sound used to attract the viewer's eyes to the visually presented link when pointed at by a PC mouse-cursor or equivalent device. Often, in order to enable users of the hyperlinked information to aim at a specific visual Hyperlink, the visual appearance of the cursor is changed when it is positioned on Hyper-linked items.

In all HTML-like linking, users should select the Hyperlink intended to be activated by either visually pointing at the displayed marking or virtually pointing at the hyperlink by using mouse-alternatives (e.g., IVR-solutions (Interactive Voice Response) where pointing is substituted by saying the link name into a microphone). The actual activation of the link is conducted by confirming the selection through a physical or virtual selection key. Consequently, the referred link is activated, enabling the retrieval of the related information and the return from such a retrieved site is usually enabled by the “BACK” function.

A definition of hyperlink is given by Wikipedia (Jul. 5, 2006)—“A hyperlink, or simply a link, is a reference in a Hypertext document to another document or other resource. As such it is similar to a citation in literature. Combined with a data network and suitable access protocol, a computer can be instructed to fetch the resource referenced. Hyperlinks are part of the foundation of the World Wide Web created by Tim Berners-Lee protocol”.

Conventional telephones, mobile communication devices and portable players are designed primarily to enable delivery of audio and basic text information to users. Most mobile communication devices are designed, first of all, to facilitate audio connections between parties. They are based on relatively limited size of display, memory and keypad as dictated by pocket-sizing, and “easy to carry and operate” requirements. While such displays, when compared to Desktops or Laptop computers, are extremely energy efficient, their limited dimensions drastically reduce their usability as visual-data sources, particularly for people on the move (walking or driving). Such constrains related to using the mobile devices, include any extraction of detailed visual information as well as selection of visual marking and prompt activation of related links as required for a short and friendly activation process.

The more modern and advanced mobile communication devices already contain browsers, which enable users access to information on the World Wide Web. Such browsers are designed to enable the users to view HTML (Hypertext Markup Language) web site information, part of which is reformatted to the small size and limited resolution of the mobile communication device display. However, activating visual hyperlink appearing on mobile phones may be found complicated, requiring both hands, stationary position of the mobile user, and, in many cases, additional accessories such as pointing device for a touch-screen or even dedicated glasses for visually-impaired users. Furthermore, stray outdoor light or other unwanted bright illumination of the display may interfere with the visual capability of users and limit the proper activation of the small-sized hyperlinks attached to displayed-information. The activation of Hyperlinks appearing on mobile devices is even more complicated when such Hyperlinks are part of a dynamic program which cannot keep the Hyperlink signs on the display for more than a limited period of time, making the response time of the user practically impossible.

The use of Visual Hyperlinks is also limited when operating other devices such as televisions with an overlay of marked display information. Current viewers are equipped with remote control devices, enabling very basic up/down and left/right movement for positioning cursors on certain graphic overlay within the displayed information. This is designed to allow an activation of certain parameters or activation of linked information or process via the set top upstream connection to a remote server. This technique is used, for example, for VOD (Video On Demand) movies selection from network based video servers, and is relatively limited in its capabilities versus the web browser and Hyperlink system used on computers.

In view of the above, there is a need for a system and methods enabling users of computerized devices in general and mobile-pocket-sized devices in particular, to easily and promptly access and retrieve additional information or activate processes related to the information streamed to or played by such devices, wherein the information is streamed via communication links or played out of the device's memory, by accessing the links to the related information or processes without the current constrains requiring visual observation of the device's display or the manual alignment and activation of a visual pointer pointing at a displayed Hyperlink.

In particular, there is a need to enable moving users (e.g., while driving or walking) to activate links to additional information and processes (AIPs) in a prompt and friendly manner using existing pocket-sized devices, bearing in mind that users' visual attention cannot be focused on the device's displays. Furthermore, as hearing can be sensed in parallel to viewing, there is a need for enabling a simple intuitive retrieval of AIPs in response to sensing their identified existence by hearing audio-related marking signals (AMSs) marking specific information items (MIIs) through using the current available basic I/O (Input/Output) interfaces of existing pocket-sized devices.

There is also a need to find a complementary method enabling users of computers, TVs, Portable players, static players and other communication devices, to access Hyper-links type links attached to MIIs without visual use of a display including, but not limited to, without manual alignment of a pointing cursor at a displayed icon symbolizing the link to an AIP, and in particular in cases when the presentation of such icon is limited due to the dynamics of the presented program.

There is also a need to enable users of mobile and land line phones, computers, TVs, portable players, static players and other communication devices, as well as automatic computerized search algorithms to search for archived data related to pre-constructed MIIs and AMSs, based on certain predefined categories for finding certain required MII-AMS combinations and consequently find and enable linking to AIPs related to such searched AMSs and MIIs. There is a need to allow simple access to such archives of such audio based AMSs and MIIs and there related AIPs for enabling simple connection to selected AIPs as well as simple way for creating, adding, editing, deleting and using such MIIs AMSs and related AIPs included in a relational form within such archives. In particular there is a need for accessing such archives while avoiding the use of visual pointing cursor on device's displays or while using automatic search machines which are currently designed for searches within archives of written text.

Thus there is a clear operational advantage to create a method whereby authorized entities can create or edit and then, when required archive MIIs together with related AMSs linked AIPs and relevant activation rules to be used by authorized recipients of information transferred through electronic devices and in particular mobile communication devices that can identify the existence of MIIs through sensing the marking signals, pointing at the existence of MII related APIs. Both the information containing the MII streamed through or played by the device, as well as the marking signals themselves, and in many cases the relevant AIPs, are based on recognized audio components. This can eliminate the need for visual-sense or visual-displays in the entire process of authorized receiving, identifying, and activating such links and then receiving or activating such AIPs.

IVR systems have been around for many years and serve users with phones who can use them to receive audio based information from automatic databases. Such IVR systems use hierarchical audio based access approach where the IVR system offers the user multiple selections (in order to move from branch to branch of a menu-tree through the selected branching points) till reaching the required information or process. Editing of the IVR menu-tree requires either editing of specific junction point between an existing higher-level branch to existing connected branches at a lower level of the tree, or adding new branching-level, between two existing levels or at a level lower than the existing lowest one of a given menu-tree. Such tasks can be complicated to manage or their results may complicate the usage of the edited menu-tree. Therefore, there is a need to enable a method for adding audio-based marking-signals (AMSs) pointing at the existence of marked information items (MIIs) having links to additional related information or processes (AIPS) that are connected to an existing IVR menu-tree branch, without complicating the existing structure of the given tree, or changing the menu-tree existing logic, while allowing a user of such a menu-tree to activate such links while using the IVR menu, use such AIPs and later, when required, connect back to the IVR menu through an optimal junction-point, as defined by the AIP.

### SUMMARY OF THE INVENTION

According to one aspect of the present invention, an identifiable distinct audio based marking-signal (AMS) such as but not limited to distinct audio tone including but not limited to “ring-tone”, tune, words, audio-enhancement, audio-variance of transmitted information, recognized voice or music or synchronized vibration, is associated with or attached to a Marked Information Item (MII) included within streamed or played audio based information file in order to point at the existence of identified links to Additional Information or Processes (AIPs), related to the MII and accessible through submission of an activation command by an authorized user or a program, in correlation with the onset or the content of the AMS associated with the MII.

According to another aspect of the present invention a device can be utilized for streaming or playing of audio or audiovisual information, originating from either local (internal to the device) or remote data source, wherein such information may contain MIIs marked by associated AMSs, that are sensed by an authorized recipient of the MII-containing file and used for pointing at the existence of identified links to additional information or processes (AIPs) related to the MIIs. According to a further aspect of the invention related to the former one, the retrieval of said AIPs can be achieved by submission of activation commands preferably but not necessarily in temporal correlation with the onset of the AMSs, or the content of the AMS, utilizing the said device's I/O ports, or the I/O ports of another device recognized by the system and/or synchronized with the streaming or playing of the MII-containing file. This allows the system to identify the requested AIP and link it to an authorized device, which can be either the device used for hearing the AMSs or the device used to activate the AIP if different from the former one, or a device specifically pre-selected to receive such AIPs by the authorized recipient.

According to another aspect of the present invention, a set of rules can be created for the creation, maintaining and containing the relations between: 1) MIIs, their type and association to other MIIs or MII-predefined groups, 2) the MIIs location within specific information files and the location of such information files within specific storage-sites, 3) the AIPs related to each stored MII, and 4) the links connecting each AIP with such MII, 5) the specific AMSs marking the MIIs including the type of the selected AMSs components and the reasoning for selecting such types, when applicable, either on personalized basis or by using a preset AMS library, enabling marking of MIIs according to an agreed set of rules connecting between AMS type and the types of MIIs and the types of links connecting the MII to AIPs and the types of such AIPs and 6) the preset activation rules of such links to AIPs including the authorization rules for such activation and, the temporal relations between the onset of the AMSs and said activation and the devices and devices' limitations used for such activation, 7) the creators or editors of the MIIs and their related AIPs and AMSs, 8) The authorization to create or edit an existing MII or a new MII in a given information file. Such set of rules can be used for either structured creation of new MIIs, or editing of existing MIIs, or simple search & find and activation of links to certain related AIPs in correlation with hearing of AMSs associated with specific MIIs, or for more complex tasks such as search for information or processes, based on selected types of MII containing files, MIIs, AMSs, AIPs or links connecting MIIs and AIPs. Operating both simple and complex tasks while using the preset rules can be managed using simple control commands originated from the I/O ports of the utilized device as well as by automatic program algorithm. The target of such control commands are search engines of relational databases or dedicated archives connecting all the parameters characterizing and related to a specific MII.

According to another aspect of the present invention in order to facilitate the requirements mentioned above, an MII archive or alternative data storage mechanism is created wherein MIIs and related AMSs and AIPs and relevant data related to the MII creators or editors and to activation and authorization rules are arranged in accordance to a predefined categorized formats enabling users or an automatic program an easy access to each of the components of the archived items. The stored MIIs, AMSS, and AIPs and activation rules can be archived in correlation to their types and content, order of appearance, relations to other MIIs included in the same or other MII containing files, and/or other MII creator, editor, operator or user predefined preferences, to enable easy access to all or part of pre-selected types of linked information or processes. Manipulating the relevant stored data related to the MIIs can be conducted by authorized devices operated by authorized users or programs while receiving such data, utilizing control commands such as, but not limited to: “Play”, “Stop”, “Back”, “Search for and present”, “Insert”, “Edit”, “Save”, “Delete” etc., originating from the existing I/O ports of the said devices, or from equivalent software commands of relevant programs.

### BRIEF DESCRIPTION OF THE DRAWINGS

FIG. 1 is a schematic graph of the temporal relations of information items within an audio based content file containing different information items streamed or played serially according to the prior art.

FIG. 2 displays a schematic graph wherein audio based information files containing different information items are streamed or played serially wherein some of the information items within the files are marked (the MIIs) with AMSs, synchronized with the MIIs and pointing at the existence of identified links to AIPs related to the MIIs.

FIGS. 3a, b, c, are flow charts describing creation or editing of MIIs and the related AMSs and AIPs.

FIGS. 3d, e, f, are flow charts describing activation and retrieval of AIPs linked to MII as well as accessing, editing and archiving processes or creating new MIIs during playing or streaming of audio-based information files.

FIG. 4a is a conceptual plan view of a mobile interactive communication system having a web based server connected to a user's computer devices, Radio and TV stations as well as mobile communication networks.

FIG. 4b is a front view of a mobile communication device having typical keypad wherein certain keys included in the keypad, can serve as the device input ports for the submission of control commands that are to be sent to connected servers or devices for activating a link to an AIP, managing the AIP activation during streaming or playing, activating a search for a predefined types of MIIs, or AMSs, or related links or AIPs, as well as for adding or editing or deleting MIIs, wherein the above mentioned operations are executed by authorized users or programs.

FIG. 5 is a flow chart of an exemplary IVR hierarchical menu-tree based architecture, coupled with MIIs and related AMSs, links and AIPs that are used for adding information, processes and links, within or external to the existing IVR menu-tree system, while avoiding any change of the original tree-logic.

### DETAILED DESCRIPTION

In the detailed description reference is made to the following terms:
a. Information file—A content file streamed or played via a computerized device or communication device, containing audio or audiovisual information and may contain MIIs and associated AMS pointing at the existence of identified links to AIPs that are related to the MIIs.
b. MII—An information item marked by associated Audio based Marking-Signal (AMS) and having links to additional related Information or processes.
c. AMS—Audio or audiovisual or audio-sensual based marking-signals—comprising of Audio, or Audiovisual or Vibrations signals, associated with the specific MII which is contained in an information file, or the AMS is contained within another file programmed to be played synchronously with the MII-containing file, for pointing at the existence identified links (such as Hyperlinks) to related information or processes.
d. Links to related information or process—Links to information or processes, pointing at the exact location of such information files or processes, including the means for retrieving such information or activating such processes by authorized submission of an activation command, related to Marked Information Item (MII) and the selected AIP, and associated with the onset of the relevant AMS.
e. AIP—Information files or processes that are linked to an MII.
f. Activation command—a short command (usually but not necessarily based on activation of a “single key” or single word or a short combination of keys or words submitted from a device input ports such as a keypad, wherein sending such command through the device I/O ports creates either connection to a specific AIP accompanied by data retrieval or process activation, or a control command related to the streamed or played AIP (e.g., “Edit”, “Delete”, “Back-to-MII”, “Pause” “Fast Forward”, “Fast backwards”, etc.).
g. Device I/O (input/output) ports—such as, but not limited to, device's keys within a keypad, computer mouse, microphone (for enabling voice activation command), wireless based input device (e.g., Bluetooth voice device, Wi-Fi voice device), IR-Remote control.
h. Process (in Additional Information or Processes—AIP)—a process may comprise certain programmable activities such as, but not limited to, connecting a communication links between parties, submitting file of information to defined destination, activating actuators, submitting payments, submitting billing information, submitting receipts and other remotely activated processes.

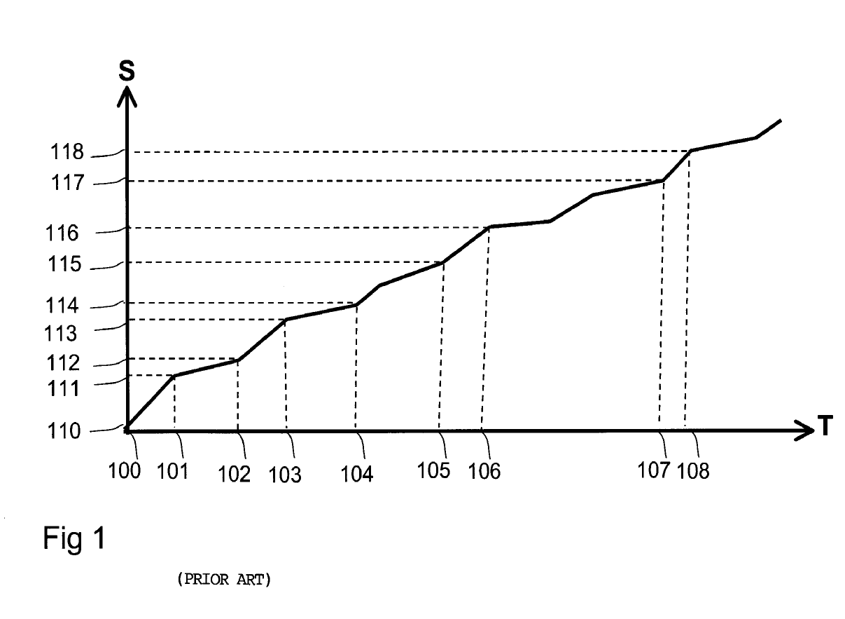

FIG. 1 describes the streaming or playing process of an information files in terms of advancing the file transfer while transmitting stored data S—within well defined and addressable memory spaces containing the entire file (S—Vertical Axis) versus time—T (T—Horizontal Axis). Assuming the streamed/played file can be stored at more than single memory range and the streaming/playing process includes pointers for smooth and prompt management of streaming/playing through continuous and synchronized connection of the different memory ranges, then the streaming/playing time intervals can be mapped against the continuously connected storage-sites or memory ranges as described. In FIGS. 1 and 2, 110-118 indicate memory spaces, 100-108 indicate time intervals.

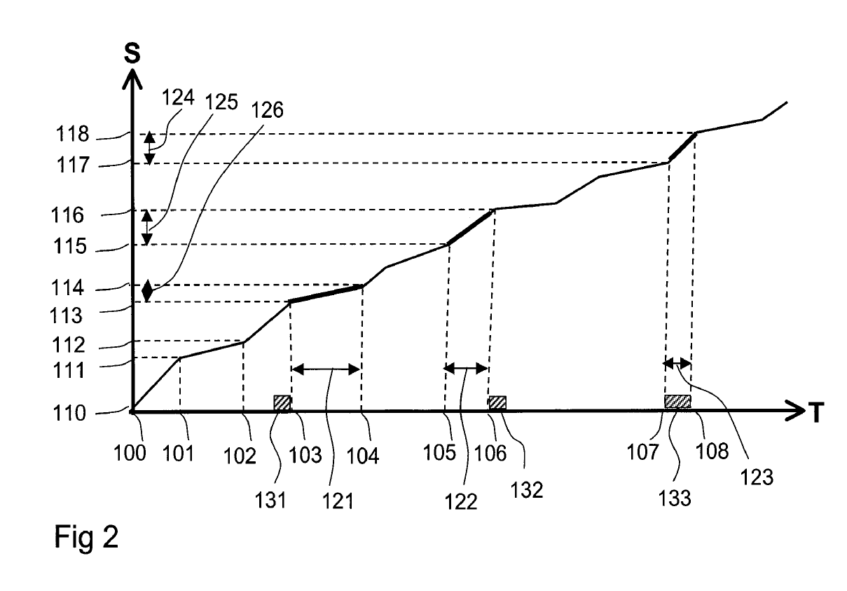

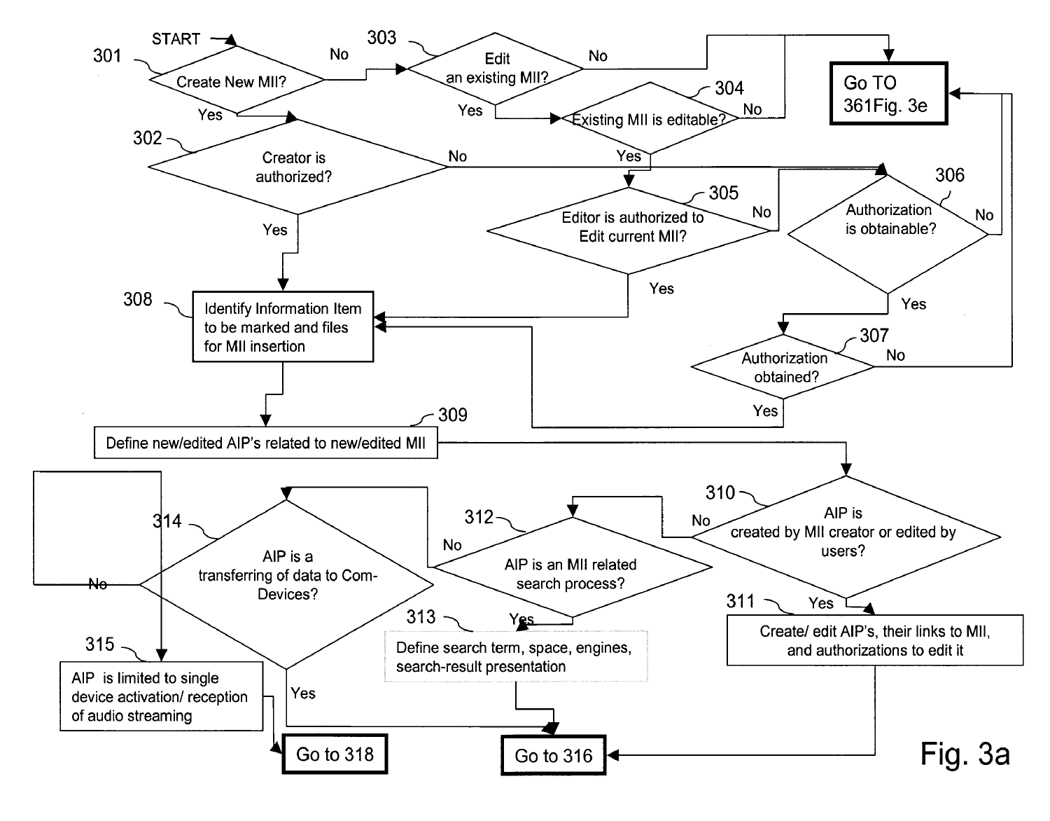

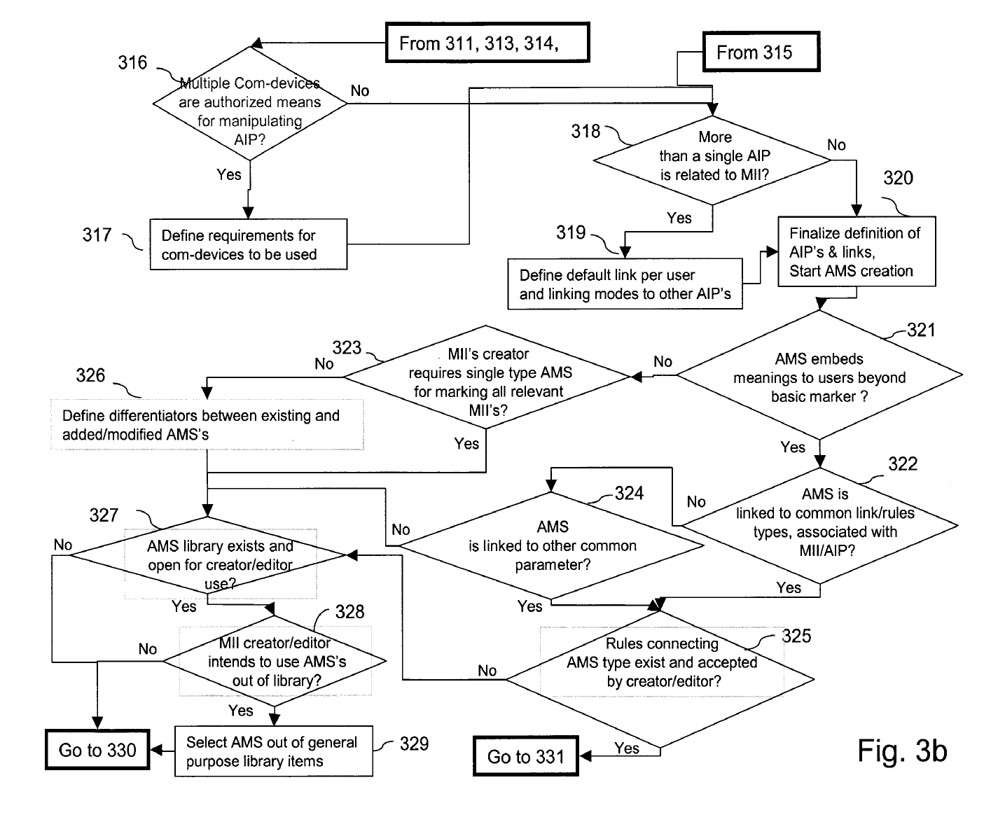

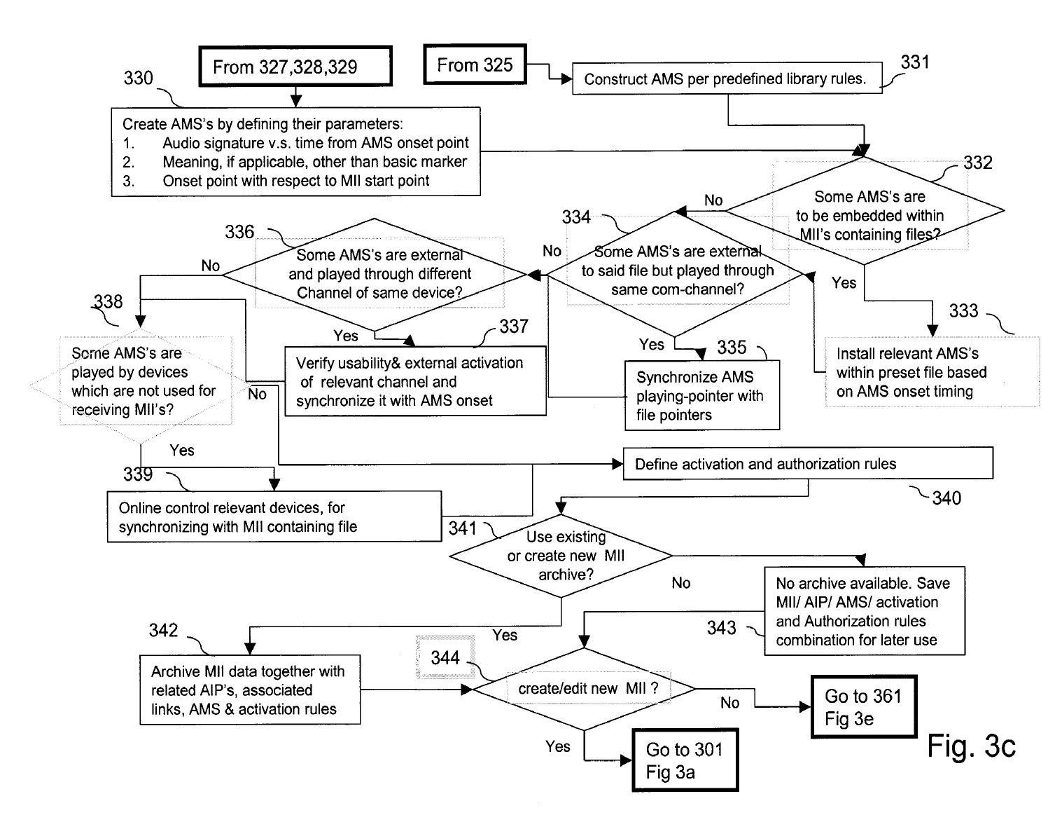

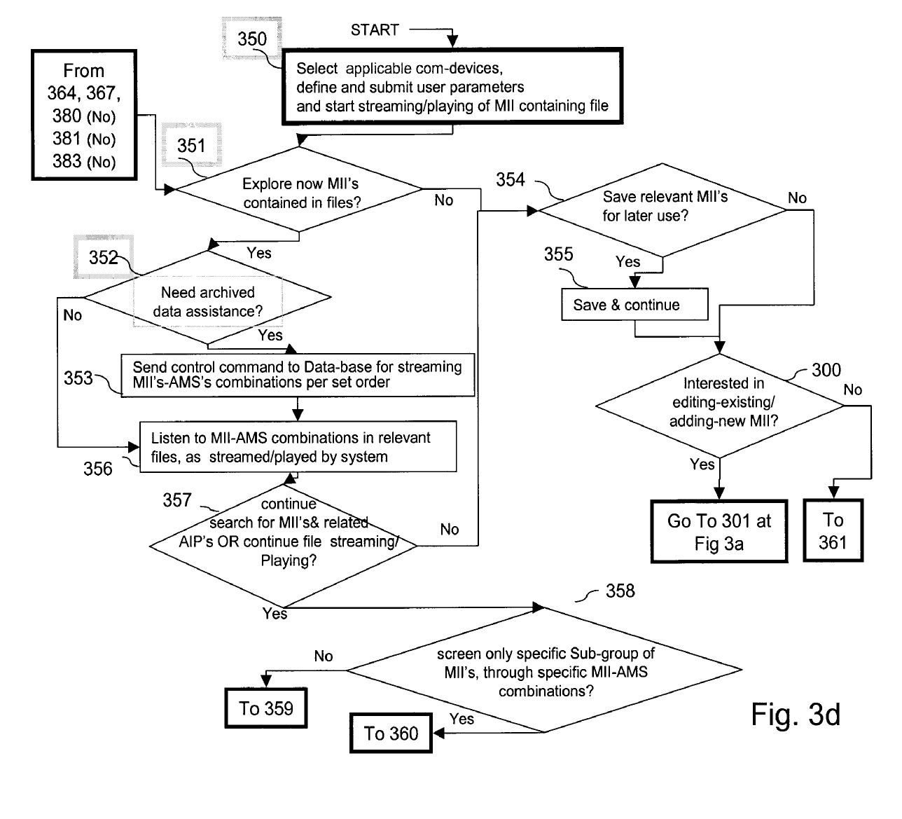

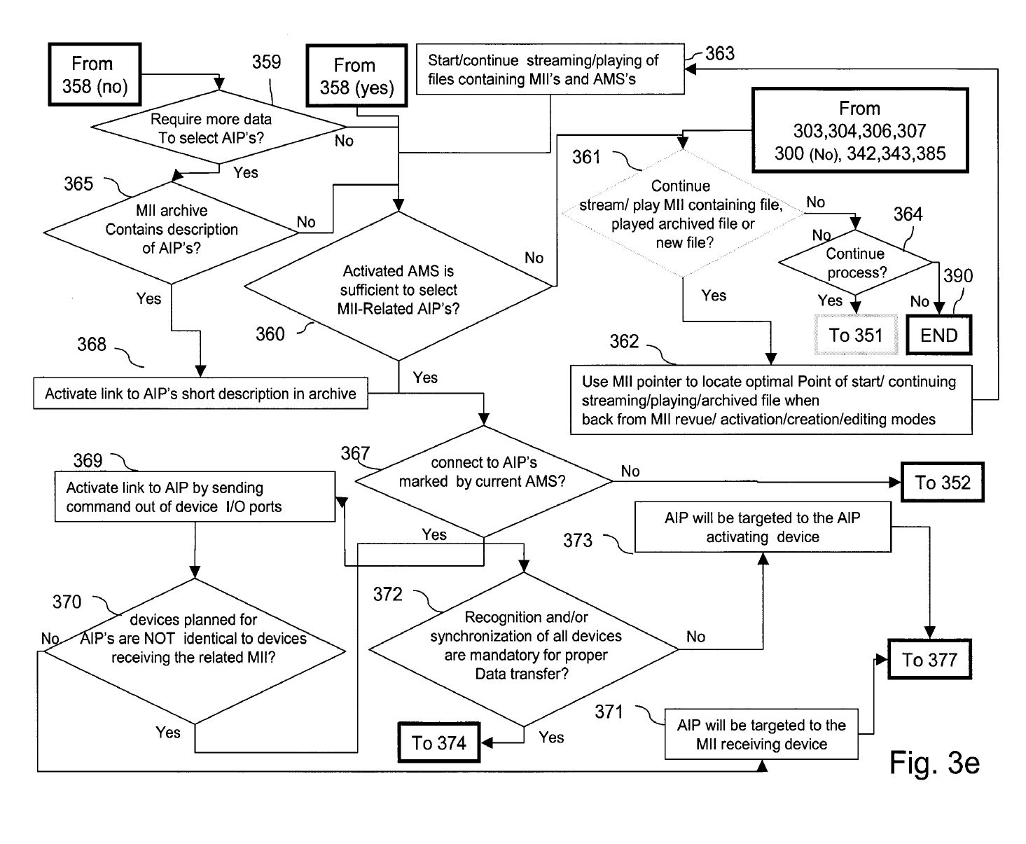

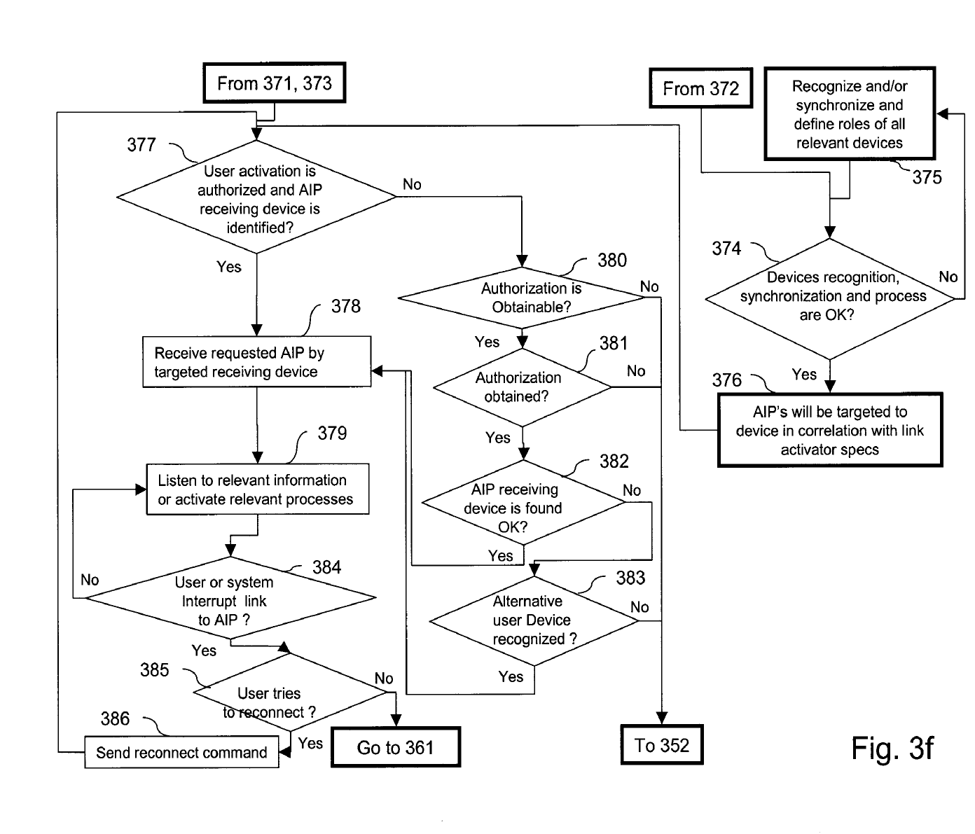

FIG. 2 describes the process of identifying and marking specific Marked Information Items (MIIs) within streamed/played information file, including building the prompt connections between such MIIs and relevant AIPs. Assuming, for the sake of example, that the MII creator aims at generating three MIIs contained within a streamed/played file, that are identified at time intervals 121 (between start time 103 and stop time 104), 122 and 123, after streaming/playing start-point and stored at equivalent memory Spaces 126, 125, and 124, respectively and the Audio-related Marking Signals (AMSs) should be embedded within the streamed/played file, then the MII creation process is based on the following stages presented graphically, in part, at FIG. 2 and at flow charts in FIGS. 3a-c:
1) Selecting information items that should be marked as MIIs (MII(121), MII(122) and MII(123), where MII(i) is the MII played during period-(i), defining j-additional information items or processes (AIP(ij)) related to each MII(i) and the links connecting each MII(i) with each of the j-relevant identified additional information or processes (AIPs) stored at well-defined connectable sites.
2) Identifying the Time ranges T(121), T(122), T(123), with respect to streaming/playing start point, or other reference in the time-domain, and the memory Spaces or Storage locations S(126), S(125), S(124) characterizing the MIIs.
3) Defining the activation rules including authorization rules, related to each AIP(ij). Such activation rules should include, for example, the period after receiving an AMS, or the event during streaming/playing of the file containing the MII, that terminates the validity of an activation command related to a specific AMS/MII(i) combination. Such rules also define the default link for connecting a specific MII(i) to certain AIP(ij) when more than single link exist, based on the recipient characteristics and authorizations or the activation circumstances. When more than single AIP can be activated by a certain authorized user, the rules also include the modes of activating non-default links. The authorization rules include rule such as, but not limited to, defining the authorizations for receiving (hearing) a specific AMS by an identified/non-identified recipient and the authorizations for activating specific links once the recipient is authorized to receive specific AMS, and if not preauthorized, the requirements for obtaining such authorization.
4) Selecting the AMSs types, wherein such type may be based on types of the relevant MII(i) and/or the types of a related AIP(ij) and/or the types of the links connecting the MII(i) and the AIP(ij), and/or other criteria defined in preset rules to be used by the general users of a system or to be personalized by the MII creator or editor or users, such as but not limited to MII priority, AIP language, etc. Consequently the selection can be based on either personal preferences and rules created by the MII creator, editor or frequent user of the MII, or on the utilization of an existing AMS library, which establishes the accepted relations between the above mentioned types of AMSs audio-signatures and the types of MIIs, AIPs and relevant links or rules, wherein system users or user-groups can further customize the libraty for optimizing it to their own needs.
5) Defining the required temporal onset and duration of the AMSs with respect to each of the relevant MIIs, namely, defining if relevant AMSs should be heard by the recipient before the start of MII, such as AMS(131) starting before MII(121) start time T(103), or after the end of the MII, such as AMS(132) Starting after MII(122) at Time T(106), or fully overlapping the transmittal of the MII such as AMS(133) overlapping M(123) between T(107) and T(108) or partially overlapping (either starting before or during) the streamed/played MII
6) Selecting the applicable options for later activation of the AMS which may include at least one of:
i) Embedding the selected AMSs within the relevant file, containing the MIIs, based on the selected onset-time and duration of the AMSs and the original audio-signal characteristics at the interface segment between such file and the AMS components. Namely, the streaming/playing pointers will take into consideration the insertion of the AMSs into the information file and the AMS-signal audio volume will be clearly but not too loudly heard while listening to the streamed/played file. Such embedding can be achieved by either super-imposing (recording) of the relevant AMS into the relevant memory storage location S used for storing the related MII, with the proper changes, if required, of the relevant definition of T, or by inserting a new independent audio-based content item, to be stored at S′ (not shown) and having all relevant connections pointers for proper onset timing,
ii) Linking AMS triggers to the relevant file, in conjunction with each MII, where such triggers can point at the required timing and the selected meaning and structure of the AMS, wherein the activation of the actual AMS during streaming or playing of the relevant file can conducted using one of the following options: a) by the device receiving the MII containing file, utilizing the AMS triggers to extract the AMS form a sub-file linked to the relevant file, and then synchronously activate AMSs that are relevant for the device user, b) by the device receiving the MII containing file and utilizing the AMS triggers to extract the AMS timing but extract the AMS, considering its original type and meaning, from a local library personalized by the device user, and then synchronously activate AMSs that are relevant for the device user,
iii) Linking AMS triggers to the relevant file as in option ii) above, but sending the triggers, synchronized with the streamed or played file, to an external device other than the one utilized by the user to stream or play the MII containing file, and where the AMSs are synchronously activated by the external device upon receiving the triggers, using options a) or b) as specified in ii) above, and transmitted through one of: direct transmittal to the user's or program's sensing means, or, transmittal to another channel of the user-device used for streaming playing of the MII-containing file for synchronous playing the MII containing file.
7) Adding the newly created MII(i) together with all its characteristics, and the newly defined AMS, the selected j-AIPs, the links between the MII and each AIP(ij), the above mentioned activation rules and authorization rules, into a predefined structured archive or any alternative storage site, for enabling a later structured search for an MII or its related AIPs based on the types of each of the MIIs, AMSs, AIPs, the connecting links, the authorization rules, the types and source of files that may contain the relevant MIIs, the recipient's predefined preference requirements, the creator or editors of the MII, etc.

In cases when the Audio-related Marking Signal (AMS) should NOT be embedded within the streamed/played file, but rather be created by an external source, synchronized with the onset of the MII during the streaming/playing process, then the following changes should be applied instead of stage 6 above—
6a) Defining the trigger, to be received by the external AMS source, prior to generating the AMS. Such trigger can be, for example, sensing the start point (or any other predefined point after start) of streaming/playing the file containing the MII together with time-period for generating the relevant AMS, sensing the exact point of streaming/playing an MII, counting the time from former AMS triggered by the external device, etc.
6b) Defining means for transmitting the AMS to recipients together with the alternative means of receiving the transmitted AMS by the recipient and when required, defining their communication protocol. Such means include, but are not limited to, receiving the AMS through the same communication device used for receiving the MII-containing file, such as the short-range wireless links (IRDA, Blue-Tooth, Wi-Fi) of a mobile phone which can be active while communicating with another source of audio-data. Alternatively, such means should also include an external device, independent of the communication device used for receiving the MII-containing file, but connected online to the AMS source enabling synchronized onset of the relevant MII and AMS, such as a communicating ear-phone or a vibration-buzzer that can be triggered by an external signal.

An example for the processes of generating, editing and activating links to MII-related AIPs (Additional Information and Processes) utilizing AMS (Audio-related Marking Signals). The embodiments are described by the high level flow-chart diagrams of FIG. 3 in which FIGS. 3a, 3b, 3c describe the creation or editing processes of the MIIs, AMSs, and related AIPs as presented in the flow-charts, and FIGS. 3d, 3e, 3f describe exploration of MIIs within streamed played files and activation of links to related AIPs.

For consistency, in general the arrows exiting on the left or right of the diamond shape conditional process in the flow description of the charts refer to “No”—negative decision, where a “YES”—positive response flows is plotted by downwards arrows. The processes flow described below with a reference to the process stages shown in FIGS. 3.

FIGS. 3a, 3b, and 3c, describe an example for a flow-chart where the term “user”, also includes an automated entity, such as a software program, follows the process of generating or editing an MII, linking it to relevant AIPs, marking it by an AMS, and defining the activation and authorization rules of relevant links.

The flow-chart starts with a check of the user intention—Is it creating new MII [301—Create New MII?], if “Yes”, the check continues to the user authorization to create an MII [302—Creator is authorized?] and if 301=“NO”, the system check the user intention to edit an existing MII [303—Edit an existing MII?] and again if 303=“YES” the system checks if the selected MII is editable [304—Existing MII is editable?] and the authorization of the user [305—editor is authorized to edit current MII?]. When the user's intentions are neither creating new MII nor editing an existing one, the system allows a return to an optimal original streaming/playing of the file. This is the file which the user entered the MII creation/editing flow, or other points of origin out of which the MII created/edited. In the flow charts, this is indicated at “NO” to [301, 303, 304]—[361—Continue stream/play MII containing file, played archived file or new file?], followed by optimal employment of the streamed or played file pointers—[362—Use MII pointer to locate optimal Point of start/continuing streaming/playing/archived file when back from MII revue/activation/creation/editing modes] and start/continue such streaming/playing mode—[363—Start/continue streaming/playing of files containing MIIs and AMSs]. If the answer to [361] is “NO” the system checks if the user intends to continue one of the alternative process-tracks—[364—Continue process?]. If “NO” the process ends—[390—END]. If however the answer is “YES” the system checks if the user intends to continue immediate exploration of relevant MIIs—[351—Explore now MIIs contained in files?] as described in more details later FIGS. 3d, 3e, 3f.

When the user is not pre-authorized to create or to edit MII (“NO” to 302, or 305 respectively), the system checks if the required authorization is obtainable for the relevant requested task [306—Authorization is obtainable?], and if “YES” and the user decides to obtain such authorization—1307—Authorization obtained?] the actual process begins as described below ([308] onward). However, when the authorization is not or could not be obtained—[“NO” to 306 or 307 in the flow] or the MII is not editable [“NO” to 304 above] and the user entered the MII creation/editing process out of streaming/playing stage of a potentially MII containing file, or other alternative origin for MII creation/editing mode, the system directs the flow as described above [361 onward].

The actual MII creation or editing process starts once the user has the proper authorizations. When such authorizations are verified, the user has to identify the Information Items to be marked, the file containing the MIIs and the location of the relevant Information Item within the files—[308—Identify Information Item to be marked and files for MII insertion]. The next task is defining the AIPs related to the newly created/edited MII by associating the AIPs to the MIIs, defining their types, their storage sites, the links connecting to such sites and relevant authorization required to activate each AIP—[309—Define new/edited AIPs related to new/edited MII].

The next stages of the flow are AIP dependent, and in particular, aimed at adding necessary clarifications to MII-AIP combinations that are not based on simple streaming of audio content, already stored in a predefined site, which can be managed by any communicating device. When the AIP is an information item or a process created by the MII creator/editor during the process of building the MII-AIP combination—[310—AIP is created by MII creator or edited by users?] then the creator/editor should create/edit the AIP, including links to the MII, and define the limitations related to the usage, editing, or adding content to such AIP—[311—Create/edit AIPS, their links to MII, and authorizations to edit it]. If [310]=“NO” and the AIP is a search process—[312—AIP is an MII related search process?], then the MII creator should define such search parameters, including the search space, search parameters and standards for presenting search results, particularly if dependent on User's com-device's characteristics—[313—Define search term, space or engines to be used].

If [312] =“NO” and the AIP is a process of transferring data file/s (e.g., “podcasting”) from a certain storage site or streaming of data other than “pure” voice files such as, but not limited to video-streaming then [312]=“YES” continue to—[314—AIP is a transferring of data to Com-Devices?], (com-device=communication device, used for transmitting or receiving information via communication connection) and after stages [312] and [314] above, when multitude of communicating devices can potentially receive the AMS connected to the relevant MII and/or activate or receive relevant AIPs—[316—FIG. 3b Multiple Com-devices are authorized means for manipulating AIP?] then the MII/AIP creator/editor should define the minimal technical requirements from users' communicating devices and the relations between several user devices, if and when activation and/or receiving of AIPs is planned to be conducted by devices other than the one used for streaming/playing the MII-containing files [317—Define requirements for com-devices to be used].

The limitations defined in [317] are eliminated if [314] is “NO”, namely, the AIP is limited to basic audio streaming to a receiving device AND streaming is directed only to the device used for receiving the MII-containing files and activating the link to the AIP—[315—AIP is limited to single device activation/reception of audio streaming], which flow directly to the last stage in AIP analysis, as the next stage after [317], namely, checking the number of AIPs related to the created/edited MII—[318—More than a single AIP is related to MII?]. If more than a single AIP is connected to the same MII, the default one, per user's characteristics should be defined—[319—Define default link per user and linking modes to other AIPs].

Once the default link is defined or if only a single AIP is connected to the MII [“NO” at stage 318], the AIP definition can be finalized and the AMS definition process can start—[320—Finalize definition of AIPs & links, Start AMS creation]. As the AMS can be used for indicating the specific type of content included in the related AIPs or alternatively to the types of links used to connect to such AIPs or at the authorizations required to activate such links, the first check in the flow relates to the full meaning of the structured AMS—[321—AMS embeds meanings to users beyond a basic marker?]. If the answer to the last check is “NO”, the flow still checks if there is a need for a single type of AMS to point at certain MIIs—[323—MIIs creator requires single type AMS for marking all relevant MIIs?]. More than a single AMS type [“NO” to 323] may be required, for example to point at data which is not necessarily related to the types of MII, AIPs, relevant links and activation rules but rather based on other parameters related to the MII creation/editing phase such as identification of creator/editor, time of creation/editing existence of comments to original AIPs, etc. In such a case the flow allows determining of differentiators between newly created/edited MIIs and former items—[326—Define differentiators between existing and added/modified AMSs].

If, however single AMS type is sufficient, its selection, as well as the selection of the multi-type AMSs defined at [326] depends on the existence of an AMS library, available for use by the MII creator/editor and the intention of the creator/editor to select AMSs out of this library—[327—AMS library exists and open for creator/editor use?], when “YES”—[328—MII creator/editor intends to use AMSs out of library?], when “YES”—[329—Select AMS out of general purpose library items]. In both cases of not selecting the AMSs out of the library or building the AMSs independently (when library is not available—“NO” at [327], or the user prefers not to use it—“NO” at [328]) the next stage is the fine-tuning of the AMSs—[330—Create AMSs by defining their parameters:
1. Audio signature v.s. time from AMS onset point
2. Meaning, if applicable, other than basic marker
3. Onset point with respect to MII start point] after which the resulted AMS can either be synchronously inserted into the relevant MII-containing files, or designed for activation using AMS triggers, said trigger defining AMS onset-timing, planned signature and meaning and employed by a device which can either play the AMSs as originally planned or filter only relevant AMSs and even automatically customize them, based on user preferences, after which the insertion of the AMS into, or its synchronization with, the relevant file begins.

Before going into these stages an example is shown of the flow branch when the answer to [321] above is “YES” (namely, there should be a well-defined linkage between the AMS audio-signature and one or more of the related types of MIIs, AIPs, used links and activation rules). In such a case, the first check if the linkage-type which can be either MII/AIP/Link/rules type dependent—[322—AMS is linked to common link/rules types, associated with MII/AIP?] or if [322]=“NO”, the AMS may be connected to other agreed common parameters such as MII priority, activating device related parameters, user preferences (such as language), etc—[324—AMS is linked to other common parameter?]. When [322] or [324] above are “YES” the flow continues to a check if there are agreed and set relations between the AMS type and its meaning and if the MII creator/editor intends to use such preset relations—[325—Rules connecting AMS type exist and accepted by creator/editor?]. If the answer to [325] is “NO”, the flow is switched to [327] described above and continue accordingly. If the answer to [325] is “YES”, then AMSs are constructed based on such preset of rules (It should be noted that AMSs may contain within their audio-signature several serial or overlapping components, each pointing at different meaning connecting the AMS to the content of the MIIs, AIPs, and relevant activation rules)—[331—Construct AMS per predefined library rules.], and the product of [331] flows with product of [330], described above, into the AMS insertion stages.

The first stage of AMS insertion checks if some of the AMS are intended to be embedded within the MII containing file—[332—Some AMSs are to be embedded within MIIs containing files?]. If “YES” the flow proceeds to the actual embedding of the constructed AMS within the file—[333—Install relevant AMSs within preset file based on AMS onset timing] and continue checking if other types of AMSs playing modes are to be synchronized with the MIIs. When not all the AMSs are designed for embedding within the MII containing file ([332=“NO”]), and after [333]), the flow checks if AMS-MII relations are based on retrieval of the AMS out of a storage location other than the MII-containing file and the synchronization requirements between the AMS and the corresponding MII. The first check in such a case is if some AMSs are designed to be stored external to the MII containing file yet played through the same communication channel in a synchronized manner—[334—Some AMSs are external to said file but played through same com-channel?]. If “YES” the process synchronizes the activation pointers of the files containing the two data items (MII and AMS) using the AMS triggers—[335—Synchronize AMS playing-pointer with file pointers], and continues as in the case of [334]=“NO”, to check if some AMSs are designed to be played through a different channel of the same device used for streaming/playing of the MII containing file (for example, in the case of a cellular phone, while the MII containing file is streamed through the main network channel (GSM, 3G, Wi-FI etc.), the AMS can be transmitted through external source received synchronously by the same cell phone (BlueTooth, IRDA etc.)). [336—AMSs are external and played through different Channel of same device?]. If “YES”, the process verifies the usability of such external channels, validates the synchronization of AMS onset and the streaming/playing of the MII containing file, and defines any limitations imposed on future users and their devices—[337—Verify usability & external activation of relevant channel and synchronize it with AMS onset].

In case [336=NO], and after [337] the last alternative for AMS insertion, playing the AMS by devices other than the once used to receive the MII, is checked—[338—Some AMSs are played by devices which are not used for receiving MIIs?]. If [338=YES], then the insertion process verifies the online control over the relevant AMS playing devices for synchronizing them with the MII playing devices—[339—Online control relevant devices, for synchronizing with MII containing file]. It should be noted that in all cases when AMS is transferred to the relevant device in the form of an AMS trigger, namely the AMS is not embedded in full in MII-containing file, then the device used to activate the AMS can either filter certain AMSs based on their meaning or customize them if so designed by the device user. If [338=NO] and after [339], the next stage, relevant for all types of AMS insertion procedures, is defining the activation and authorization rules for each AMS-MII combination, including, but not limited to, the following examples i) masking rules imposed on certain non-authorized users, as well as masking rules requested by authorized users for minimizing the number and types of AMS-MII combinations transmitted, by preventing the masked users from hearing certain AMSs, or ii) the necessary logic required for responding to an AMS when either the activating device or the planned AIP receiving device are not necessarily the devices used to receive the MII, or iii) the authorizations rules defining which of the users can activate each AIP, once exposed to AMSs, under what terms and if not preauthorized, can authorization be obtained—[340—Define activation and authorization rules].

Once the AMS-MII coupling is done, the creator/editor can save the results for future use or search. If there is an existing MII archive or the user elects to start building a new MII archive—[341—Use existing or create new MII archive?], then the relations between the newly created/edited MII, its related AIPs, AMS and relevant activation and authorization rules are stored within such structured archive for achieving simplified “search & find” for any of the stored data components and personalized processes by a future user—[342—Archive MII data together with related AIPs, associated links, AMS & activation rules]. If an archive is not existent or cannot be used, the user can still save all newly-created relevant parameters and the relations between them, for example as suffixes of the MII containing file—[343—No archive available. Save MII/AIP/AMS/activation and authorization rules combination for later use].

Once the newly created/edited MII with all its related AIPs, AMSs links and activation rules are saved either utilizing an archive [342] or on a provisional basis [343] the flow lets the MII creator/editor select between continue with MII creation/editing and going back to streaming/playing of data which became the origin of the MII creation/editing. When [344—create/edit new MII?]=YES, the process is switched back to [301] described above, if [344=NO], the user is switched to an optimal point at the MII containing file from which the process started through—[361 to 363], or it allows the MII creator/editor to continue with MIIs related tasks—[363 to 352 as described above], or to END the process—[361 to 390].

The processes of activating MII related links in response to hearing an AMS with an intention to reach related AIPs is described in the branches of the flow presented in FIGS. 3d, 3e, and 3f. The selection of the communicating devices for all MII related activities is important, even critical, for a correct usage of the MII-AIP linkage. In many cases user ID is defined by the communicating device ID numbers and is used as a key parameter in defining user authorizations to activate certain MII related links or even for hearing certain AMSs, or for incorporating preset user personalization parameters, defining user's preferences or limitations, which, in most cases, should be submitted prior to activating the relevant links. It should be noted that certain personalization parameters can be extracted automatically. For example, knowing the network to which the communicating device belongs may be used for selecting the default language used upon MII related link-activation. In more complicated cases, when the user is allowed to receive the MII-containing-files by a given device and to activate the links to certain AIPs or even to receive the AIPs by different (other) com-devices, the relations between the different devices planned to be used by the user are sometime required to be known to the system prior to the multi-device activation process.

It should be noted, however, that the need for well-defined relations between different user devices is case-sensitive, and under certain circumstances it is not required at all. For example, MII-containing information can be broadcasted or multi-casted to specific user groups over channels such as digital or analogue radio or TV, through the Internet over governmental data distribution channels, or through local Audio or Audio-Visual transmission to certain user-groups within a geographically-defined area or network-defined grouping such as stadiums, schools, theaters, shopping malls, campuses, disaster areas, work-groups, participants of certain events, etc. In such a case, the user can receive the MII-AMS combination through the utilized receiving devices (e.g., radio, TV, local audio-transmission system), and respond by using communication devices such as, but not limited to, mobile or land-line phones.

The system, being responsible for transmitting the MII-AMS containing information, receives the user's link activation commands generated as a response to the transmitted MII-AMS combination. Based on the processes defined by the AIPs, the system may respond to each such activation command by transferring the relevant AIPs to the link-activating user on the mere basis of temporal correlation between the broadcasted/multi-casted MII & AMS, and the received activation message. Alternatively, if such temporal correlation is not sufficient for identifying the MII or AIP, the activation command can be expanded to include more data for identifying the MII or the AIP. Examples for such expansion are audio-trace of either the AMS, or the MII, or a combination of both included in the activation command, a specific destination to which the activation command is sent in response to hearing the AMS, a system-generated dialogue with the activation message sender for optimizing the personalized service, or a combination of the above means. Relevant AIPs can then be linked to the user either over the open communication link generated between the calling device and the relevant communication server, or between such server and a different receiving device (other than the one used for link activation purposes), if such device was predefined by the link activating user.

As an example, the system can broadcast a song or Audio/video (MII) clip, such as but not limited to, a news item, at certain timing via defined radio/TV channel and attach to the broadcasted item an AMS at certain timing during the streaming. The AMS is recognized by the listeners as an invitation for submitting activation command for transferring the full audio or audio-visual content to targeted receiving devices, enabling personal replay of such content and connection to related expanded data. The submission of the activation command triggers a process during which the server receiving the command identifies the required AIP through temporal correlation between the command and the MII broadcasting time and then it checks user's authorization for receiving the requested AIP. Such authorization can be automatically approved if the user is, for example, a pre-registered subscriber to a certain service or it can be obtained online if the user wishes and is allowed to obtain or “purchase” it through a “one-time” or permanent subscription basis, or it can be blocked if the user does not fit a certain profile as required by the MII-AMS combination creator or broadcaster (such as for example user age-group). Once the authorization is obtained the server activates a connection between the user and the AIP. As the entire process-flow as described below is conducted whenever an AMS is transmitted and a user responds, within a given time-frame, by an activation command, such system can reach a very high resolution in managing the economy and authorized distribution of requested content items by users. Yet, it is extremely simple to operate by all types of potential users, and in particular mobile-users, to a level that submitting an activation request can be as short as pressing a single “short-dial” key when the user ID is recognized and/or automatically pre-authorized by the system.

Therefore the first stage in the activation flow is selecting the proper communicating devices, matching the requirements enabling the user to be authorized by the system for AIP activation and for being connected to the relevant data sources—[350—Select applicable com-devices, define and submit user parameters and start streaming/playing of MII containing file]. Once the devices are selected and personalization completed (when required), the user may elect to use MIIs through three major alternative tracks—the first is exploring existing MIIs within certain files, using archived data without necessarily stream/play the entire MII containing file; the second is based on streaming/playing the MII containing files and responding to relevant AMSs online; and the third, which was described above in FIGS. 3a, 3b, 3c, is creation/editing of MIIs within a given file.

The description below presents the first and second tracks and their optional interaction with the third track described above. The first check of the flow is focused on the user MII related intentions—[351—Explore MIIs contained in files?]. A “YES” answer to that check means that the flow is in the first or second tracks defined above and in response, the user is required to select between archive-added selections by YES to [352—Need archived data assistance?] or direct streaming/playing of the MII containing files, by NO to [352]. If [352=YES], the user sends an activation command to stream all archived relevant MII-AMS combinations contained in the investigated files—[353—Send control command to Data-base for streaming MIIs-AMSs combinations per set order]. Such a command can be interpreted by the system in several ways but the most intuitive system response is streaming/playing of all such combinations cyclically, starting from the last-heard AMS or the first AMS in the file if no streaming/playing occurred prior to receiving the command. In certain cases the user can also request the play of the MIIs excluding the attached AMSs when, for example, the meaning of AMS-type can be ignored. The simple meaning [352]=NO, which is the most probable default case of the second track, when a user passively listens to any type of MII containing files, is switching the process to [356—Listen to MII-AMS combinations in relevant files, as streamed/played by system].

Accordingly, [356] is operated by both the first and second tracks for listening to the product of the activation command. Knowing that MII-AMS exploration is intended for either selection of a specific MII for the purpose of activating related links to AIPs or adding/editing specific MIIs, or for saving relevant combinations for a later use, the current track is split into the relevant options according to the following flows: The system constantly checks if the user is still interested in MII dedicated exploration—[357—continue search for MIIs & related AIPs OR continue file streaming/playing?]. A “YES” to [357] keeps the system waiting for selection of specific MII as described below (in most standard cases the default status of stage [356]). A “NO” to [357], for example in a form of a certain activation command while being at [356], can split the flow into the alternative track and the system checks if the user wishes to save all presented MII-AMS combination for a later use—[354—Save relevant MIIs for later use?]. If “YES” the system saves the relevant combinations in response to the user command and continue [355—Save & Continue] as in response to [354]=“NO”. The next stage checks if the user intends to add/edit certain MIIs related to the presented combinations—[300—Interested in editing-existing/adding-new MII?]. A “YES” to [300] sends the process to MII creation/editing flow described above and starting with [301] at FIG. 3a. A “NO” answer to [300] starts a check if the user is interested in returning to the continuous flow of the relevant MII containing file described above leading to either optimal return to such a file [361] or, selecting new MII-containing file for streaming or playing or terminating the process at [390].

A “YES” to [357] starts a process of further investigating the MII-AMS combinations. If the command control for streaming/playing the combinations out of a database already screens a specific group of MIIs (due, for example, to preset personalization parameters), the next check is if it is sufficient for selecting specific links to AIPs. Therefore if the check—[358—screen only specific Sub-group of MIIs, through specific MII-AMS combinations?] is YES, the user can decide if the activation of the AMS is sufficient to select a specific AIP using the check—[360—Activated AMS is sufficient to select MII-Related AIPs?] and continue the connection process as described later. If the answer to [358] is “NO”, the system checks if the user requires more data to select a specific AIP—[359—Require more data to select AIPs?]. If “YES” and MII archive or alternative storage site contains short description of the AIPs—[365—MII archive contains description of AIPs?], the user can activate, by a control command, the file containing the short description which is either streamed (if stored on remote server) or played (if transferred to user's device memory) as a preview, prior to activating the link to the relevant AIPs—[368—Activate link to AIPs short description in archive] and if such description helps to select AIP for activation and the user decides to connect such AIP it merges with [360=YES] to check—[367—connect to AIPs marked by current AMS?]. If the user responds positively (YES to [367]) by sending an activation command in correlation with the onset of the relevant AMS—[369—Activate link to AIP by sending command out of device I/O ports], the system needs to clarify the expected track of the requested AIP. If the devices planned for activating and/or receiving the AIP are not identical to the one used for streaming/playing the MII-containing file—[370—devices planned for AIPs are NOT identical to devices receiving the related MII?]=YES, the system should check if the recognition and/or synchronization and/or expected role of all relevant devices is mandatory for the process—[372—Recognition and/or synchronization of all devices are mandatory for proper Data transfer]. If such demand is not mandatory [372=“NO”], the system will connect the AIP to the activating device unless other device was clearly define as the AIP receiving channel—[373—AIP will be targeted to the AIP activating device].

If the answer [370]=“NO” (namely, a single device is used for the entire process), the system will define the MII-receiving device as the AIP target—[371—AIP will be targeted to the MII receiving device]. When [372]=“YES”, the system checks if devices' definitions and/or synchronization are OK—[374—Devices recognition, synchronization and process are OK?]. If such definition is not complete, ([374]=NO), user should finalize it prior to connecting AIP—[375—Recognize and/or synchronize and define roles of all relevant devices]. If however [374]=“YES”, The AIP will be targeted to the receiving device as defined by the user, in response to recognizing the activating device and correlating it to the relevant MII—[376—AIPs will be targeted to device in correlation with link activator specs].

Going back to the branch where the answer to [358] is “YES” or the answer to [359] is “NO” or to [365] is “NO” and—[360]=“YES” the process flows to [367] as described above. If however [360=“NO”] the process flows to [361] onward as described above. If [367] above is “NO” the process flows to [351] as described above, enabling the user to reconsider its next MII explorations.

Once a user sent an activation command for an AIP ([369] above), and the system verifies the device to which such AIP should be targeted at or connected to [371, 373, and 376 above], the system continues with checking user's authorization to activate the requested link—[377—User activation is authorized and AIP receiving device is identified?]. If “YES” the system connects the user's at least one device to the relevant AIP—[378—Receive requested AIP by targeted receiving device] and the user can listen to, watch and listen to, or activate processes presented by the streamed/played AIP—[379—Listen to relevant information or activate relevant processes]. If [377]=“NO”, and authorization is obtainable—[380—Authorization is obtainable?] and the user managed to obtain such authorization—[381—Authorization obtained?], and the planned AIP receiving device is OK—[382—AIP receiving device is found OK?] or if [382=“NO”], and an alternative device is defined and recognized by the system—[383—Alternative user device recognized?], the process flows to [378] and continues as described above. If, however, authorization cannot be obtained or user did not manage to obtain it, or no receiving device is connectable—(all of [380], [381], and [383]=“NO”), the process flows to [352] and continues as described above.

At any point of being connected to the AIP the user can terminate the link and the system can do it automatically when connection-time or user-authorization is over, or when communication link fails—[384—User or system Interrupt link to AIP?]. If such termination occurs the user can decide between trying to reconnect the link—[385—User tries to reconnect?] and if “YES” the user sends reconnect command [386—Send reconnect command] and the process flows back to [377] above. If however [385=“NO”] the flow is directed to [361] where the user can select between continuing streaming or playing of the MII-containing files, exploring MIIs (through [364] to [351] and flow as described before) or ending the entire process through [364] and [390—END].

In another embodiment of the present invention the construction of an optimal AMS depends on different parameters, to be analyzed during the MII creation process. Such parameters can include, among others and without losing generality, the characteristics of the expected MIIs user-base, the types of the created MII and the files containing such MII, the diversity of available AIPs related to each MII and the restrictions related to or authorizations required for activating the links to such AIPs. For example, it can be expected that when the created MIIs are built for a personal use by the MII creator, then personal preferences may dominate the AMS construction process, while a creator of MIIs, to be used by the general public, may wish to construct the AMSs utilizing AMS library, when applicable, which accumulates the accepted and agreed relations between the AMSs components characteristics and related types of MIIs, AIPs and associated links or activation rules.

Further examples for optimizing the attached AMS audio-signature to its MII is done by taking into account the audio background signals of the containing file, the variance of different MIIs contained in the same file, and the preset personalization by the file recipient. Such considerations may cause, for example, selection of different types of AMSs to be embedded in different types of MII-containing files, such as “free speech discussion”, “reading out of text-books or encyclopedias”, “audio-guidance”, “musical pieces”, etc. Furthermore, such considerations may be optimized, without limiting the generality of the method, for: 1) automatic marking of similar types of MII such as auto/manual recognition of a speaker and allocation of a predefined AMS to that audio-source; 2) automatic/manual marking of high-priority content, or content related to specific category, as defined by the MII creator, or editor, or by the MII recipient, through personalization, with specific predefined AMS tagging, enabling fast automated or manual search processes within the containing files; 3) Linking the AMS type or even the actual onset of an AMS to the recipient authorizations for activating the AIPs related to the MII marked by that AMS, 4) Selecting the AMSs for each MII per predefined preference list personalized by the user, and utilized for coupling the AMSs to MIIs upon building the data file for streaming or playing by a specific user, or storing by a user at a personalized storing site. 3) and 4) above are easily manageable using the AMS trigger technique, where the user device can be programmed to filter or customize per user preferences specific MII-AMS combinations.

Thus if a recipient is not positively identified as an authorized user of the related AIP, or if the user selected not to activate the method in relations with specific types of MIIs or specific types of APIs, the AMS can be automatically deactivated for masking the existence of the related AIP, or, alternatively, when authorization is obtainable, the AMS audio-signature can include a component, indicating that user authorization should be obtained prior to activating the AIP. However, when an authorization is obtained (for example by an online password insertion, or commitment to pay usage fees, etc.), the AMS is reactivated or modified (audio-signature-wise) for enabling access to the AIPs.

AMSs in general, and AMSs having full or partial temporal overlap with the MII in particular, may be based on incorporation of certain word enhancement effects, change of intonations, background tunes, overlapping vibrations and/or modulated visual signals (such as flashing light). AMSs design can be very simple such as a single audio frequency at constant amplitude and fixed duration. On the other hand, AMSs can be designed to present the flexibility required to reflect personal preferences, such as preferred music adapted to certain timing and mood of the person accessing the AMS, or to indicate the specific types of their MII, AIP and the links between them, using one or several building blocks (components) taken from audio based effects library, or created by the MII creator or editor for personal/public use.

An example for a very basic and simple AMS is a short (less than 300 ms) single-frequency audio signal (“bip” at the peak sensitivity of audible-frequency, e.g., the 1-2 KHz range) having moderately balanced amplitude in the range of comfortably acceptable decibels level vs the MII audio level, wherein the AMS is activated, for example less than 1 second before the beginning, or less than 1 second after the end of streaming/playing the related MII. In such a simple case, an AMS recipient should only be notified in advance, for avoidance of ambiguity, about expected temporal relations between the onset of the AMS, its related MII and the activation command of the relevant links to AIPs or the commands required to return from such linked sites to the original streamed/played file.

A more complex type of an AMS can be, for example, without limiting the generality of an AMS structure, a signal based on combination of multiple audio or audio-visual or audio sensual components where the first and earliest occur prior to the onset of the MII, used for alerting the recipient, regarding the type of the forthcoming MII and the existence of identified accessible AIPs, wherein the second component is overlapping or partially overlapping the MII, indicating the type of the related AIPs, and the last component occurs after the second and indicates the type and number of related links, as well as other data, related to such links. Such related data may comprise of link activation costs and authorization requirements, networking bandwidth requirements, size of linked information file, language of content, security requirements and other parameters required ahead of link activation.

In another embodiment of the present invention, the systematic linkage between the audio-signature of single or multi-component AMSs and their relations with types of relevant MIIs, AIPs, associated links and activation rules, is used for enabling new methods for content-based fast-search for data. Such a search utilizes search-key elements that are either related to the said audio-signature or to the types of MIIs, AIPs, relevant links or relevant rules, all of which can be either personalized by a user or accepted by a group of users, employing common rules for selecting AMSs audio-signatures. Two major search modes can be based on the methods described herein. The first search mode relies on direct scanning of the files containing the MIIs in search of proper fit between the search-keys, translated into audio-signature and certain characteristic of the AMSs related to the scanned files. The second mode can be based on searching for attached digital files characterizing the AMSs, MIIs and AIPs designed to be easily accessed and analyzed by automatic search machines. Thus the second search mode usually relies on searching of an archive/built or used (if formerly established by others) by MII creators for archiving the entire chain of relations connecting MIIs, their content, their location within certain files, the storage address of the containing files, attached AMSs related AIPs through associated links, an agreed library of AMSs and AMS' component types, and set activation rules.

The activation of either one or both AMS-based search-modes can be as simple as a prompt extraction of all the MIIs included in a given set of audio-related files, by submitting an activation control command, out of the receiving-device input ports. In response, the system reacts by playing and/or saving the relevant MIIs-AMSs combination according to a preset order such as “AMS timing after file start-point” or “Grouping by AMS-type followed by internal ordering according to a the time-stamp of the MIIs within preordered groups of files”. The MIIs in the archive file may also be selected to be heard by the user without their related AMS but knowing that related data embedded in the AMS audio-signature may not be available when considering AIP selection.

A more complex AMS-based search, either preset or customized online, enables smart screening of the MIIs according to search-keys that are embedded in either single or a group of parameters such as AMSs types, certain components constructing the AMSs reflecting MII types, AIPs types, MII generation process history, AIPs types, activation rules and limitations, including but not limited to technological requirements, authorization rules and activation economical parameters, MII creator priorities, recipient predefined priorities, and advanced default rules for search-key combinations which are preset in advance.

In another embodiment of the current invention the default AIP linked to a certain MII is selected based on the characteristics or preferences of the recipient of the MII containing files, so that a different recipient may be connected to a different default AIP upon activating the links marked by the same AMS. The reasons for correlating the default links with the identification of the recipient can vary from user preferences (e.g. language or fields of interests) or MII creator preferences (namely, the links that the creator would like to expose to a certain user) to pre-approved authorizations or online obtained authorizations, dependent on the user ID. In an example of the versatility of the AIP use, different users responding to the same AMS will activate AIPs relating to specific MII, such as, but not limited to, detailed advertisement data generated by the MII creator/editor, adapted to the users' profiles.

The control commands generated by a user or program can be based on the existing I/O ports of the device used for activating a link to an AIP or to send any other control command to the system while, before, or after receiving information. The methods included in the current invention enable using a single port, such as a single key included within a device key-pad to generate a control command for execution of system operation. More complicated commands can be based on the usage of more than single port (e.g., more than single key) to construct a command wherein such ports can be activated either serially or in parallel, utilizing existing features of the communication devices, and allowing either DTMF or IVR or internet-based or a combination of the above for linking the user or program with the server. Alternatively, when a software agent is imported and installed on the communication device, the generation of a control command is managed using said software agent which can enable personalized simplified links between each user and the system. The resulted control commands can be based either on an accepted set of rules used by all MII creators, editors and users or alternatively can be personalized by an MII creator or editor upon building new sets of MIIs and related AMSs, AIPs and activation rules.

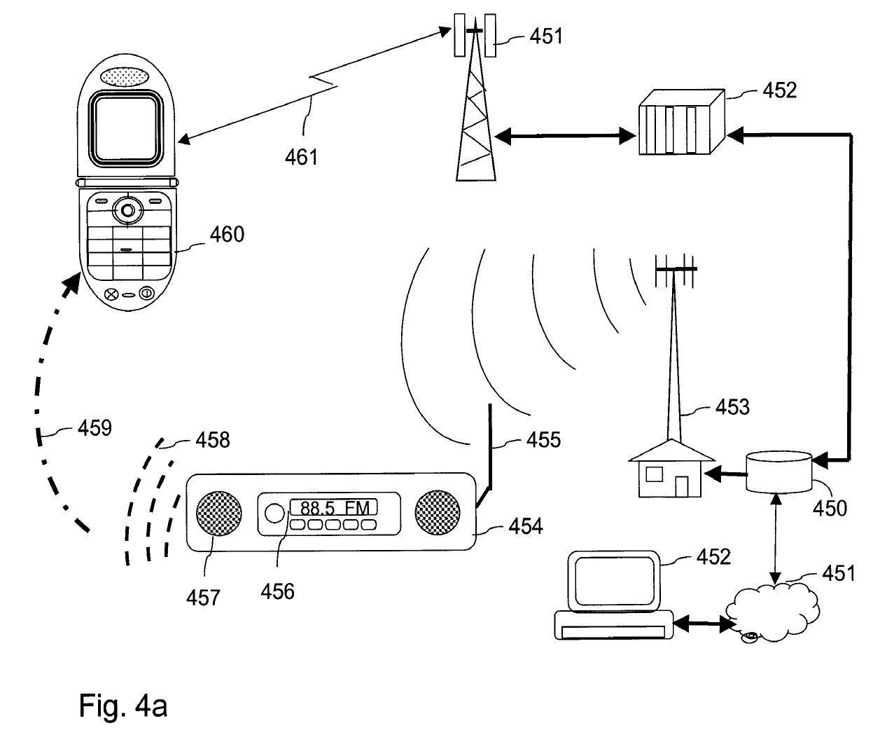

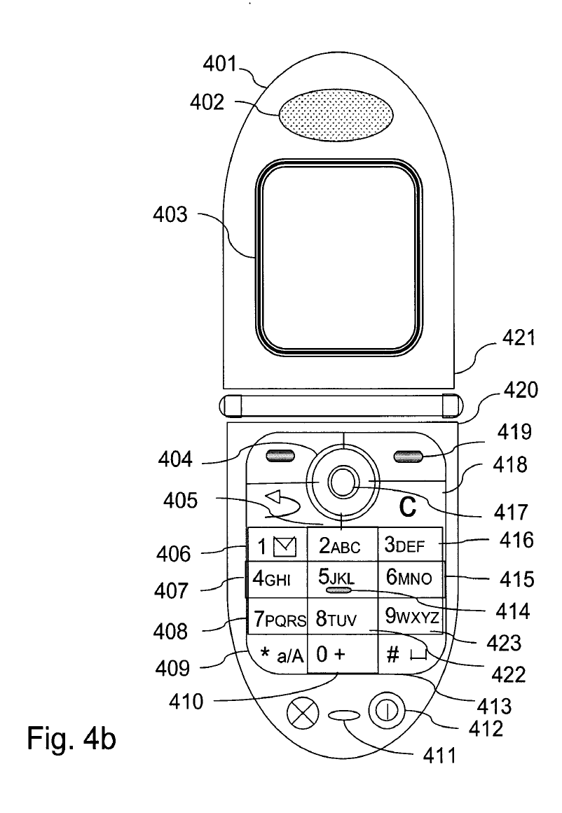

FIG. 4a describes an example of a mobile interactive communication system having a communication server 450 connected to users through their mobile devices such as 460, utilizing applicable wireless networks, such as 461 through 451, 452, and through computerized devices 462 via applicable networks such as the Internet network 463, also connected to the Radio and TV stations 453. The figure is applicable to both system architectures, including i) a centralized operation of the system in which server 450 controls the entire operation, and the user devices, such as 460 are used only as means to submit activation messages, and if authorized and qualified receive some of the AIPs, and ii) a distributed architecture in which the user device 460 can be a part of a distributed server functionalities such as for example be used to monitor authorizations or even monitor and filter out specific MII-AMS combinations when the device itself is used to receive the MII containing files, or even manage a local archive.

Users receive information streams via broadcast information over the air 464 by antenna 455 of using devices such as for example car radios 454 or other type of receivers such as TV or mobile devices 460. The mobile device 460 may receive the information from the mobile station 451 via the mobile communication system 452 using the mobile wireless spectrum schematically marked by 461, or via dedicated radio/TV spectrum directly from station 453, or via the Internet connected to the device utilizing the mobile wireless spectrum or other wireless spectra such as Wifi, WiMax or others.

In the example of FIG. 4a, the user may tune to a station 456 such as on a car radio. The radio broadcast information is heard via the audio speakers 457 schematically shown as audio signals 458. Upon hearing AMS attached to certain MII, a user may activate a control command on a mobile device 460, submitting an activation command via the wireless communication spectrum 461 and the base station 451 to the mobile communication center 452 which route the information to the Communication server 450. Upon receiving the activation command from the user the program at the communication center identifies the user and validates the authorizations required for activating the requested process, such as delivering information to the user or to other users as predefined by registration process to the service of said user. The information maybe sent to the user via a mobile device 460 or by submitting information to user's other devices such as 462.

Upon decoding the activation commands submitted by the user while activating the interactive session or during the interactive dialogue between the user and the server, the communication server 450, may start a process, based for example on the activation commands' timing, together with the decoded data embedded in the activation messages, the user ID and predefined preferences which could be set by the user prior to using the system. Other correlation techniques can be used to match the user and the requested AIP. Such techniques may comprise the use of one or more of a) the user's selected communication channel for sending the activation command, b) the location when responding to AMS, based on such as routing information, embedded GPS information, correlation with the Cellular cell used by the user or the source of the user's upstream in the case where the user response via its CATV or IPTV or telecom networks c) a portion of the AMS, transmitted as part of the activation message, d) a portion of the MII, transmitted as part of the activation message, e) a portion of the file containing the MII, transmitted as part of the activation message.

From the example given in FIG. 4a and other earlier figures, a person of ordinary skill in this art would understand that a number of different embodiments of the present invention are possible. These include:
1. A mobile device, such as a mobile phone, personal digital assistant wireless device, satellite linked positioning or communication device, interactive radio device, Interactive TV devices and numerous other mobile devices and nomadic devices (such as remote controls), programmed to allow users access to and use of MIIs, AMSs, and APIs and interaction with servers for the further manipulation and processing of MIIs, AMSs and APIs according to the flow charts of FIGS. 3a-f.
2. An electronic memory, such as a memory card or other memory device, storing a set of instructions to enable a mobile device to be programmed such that it qualifies as a device listed at 1 above.
3. A computer joined to a network of computers, programmed to provide users access to and/or to facilitate use of MIIs, AMSs, and APIs.
4. An electronic memory, such as a CD, DVD, flash memory, or any other memory device, that contains the operating instructions to allow a computer to be converted into a specialty computer listed at 3 above.

Without limiting the generality of the described method, FIG. 4b presents an example for allocating I/O ports for creating a set of control commands required for both creating as well as activating MIIs and related AIPs. The figure describes a typical mobile communication device [401] with common basic inputs and outputs ports such as keypad keys [406] [407], Audio speaker [402], Microphone [411], Display [403], vibration source [420] and LED based light source [421]. According to certain embodiment of the invention, a user of a mobile communication device is capable of listening to audio or audiovisual information streams or audio-based information played out of the mobile-phone memory which can include MIIs marked by AMSs pointing at the existence of identified link to AIPs that are related to the MIIs. Alternatively, the user of the mobile device can listen to the streaming or playing of the file containing the MIIs marked by the AMSs utilizing other source of data, which is not the mobile device itself. The device input ports can be used by a recipient of the MII containing files for submitting short activation commands to the system handling the MIIs and related AIPs. The activation commands can be sent over the mobile communication network infrastructure (such as GSM, CDMA, or advanced 3G, WCDMA type systems), utilizing one of the relevant networks' applicable channels, such as, but not limited to—control, channels, voice channels, data-channels, short messaging channels, Internet Protocol (IP) based channels,—to other computerized devices (which store either the MII containing files or the related AIPs) or to a local database if all or part of the relevant data was file-transferred to the mobile phone memory. Alternatively, the activation message can be sent using a short range intermediating device communicating with the short range intermediating device communicating with the mobile device short-range wireless channels (e.g., Blue-tooth, Wifi, Zigbee, UWB or IRDA) and connected to any alternative wireless or wire-line links to the system server.{claim!!) The activation commands of the relevant links can be sent either while receiving the streamed/played MII containing files in correlation with the onset of the AMSs, or while all or a well-defined part of the MII-AMS combination is transmitted to the recipient in response to certain activation command, after being synthetically extracted out of the relevant MII containing files, or in response to activating a search mechanism based on the audio-signature components building the AMSs, or any other search & retrieve mechanism offered by the MII-AMS-AIP archive.

In one implementation of the current invention, activation commands are assigned to the device input ports. The following is only one example of the functions which can be implemented utilizing a standard keypad of a basic mobile communication device as described schematically by FIG. 4b. Other tasks or different types of control commands may be assigned to keys or combination of keys for enabling further user interaction with the system and methods included in this invention.

In the current example the device keyboard of FIG. 4 is assigned the following control commands:
[413] “#” key—Activate default link to default AIP linked to current MII marked by last heard AMS. “#” also acts as a “Select” command.
[409] “*” key—Go back to the optimal point in the streamed/played file out of which the AIP was selected (also the reverse action of [413] “#” key).
[406] “1” key—Connect/disconnect to voice communication link via such as soft-switch connecting to such as voice recipients on communication networks.
Keys “4”, “5”, “6” serves as the audio “player” control, same as the common tape recorder, DVD, CD player, VCR, and other home and network based players:
[414 ] “5” key—Start/Pause current streamed/played audio-based file (toggle).
[415] “6” key—FF—Fast Forward. Multiple key pressings increases the rate cyclically.
[407] “4” key—FB—Fast Backward. Multiple key pressings increases the rate cyclically.
[416 ] “3” key—Retrieve all MII-AMS combinations included in current MII-containing file, or the AIPs short description once a certain MII-AMS is selected
[410] “0” key—Mark point of new MII, indicating insertion point of new AMS, while second press of “0” start cyclical presentation of optional AMSs, and then # used for selecting AMS to be used and “*” to “Go-Back” to AMS list.
[422] “8” key after AMS selection is used to record user's own audio-AIP related to current MII, “1” (after “8”) attach recorded AIP to MII and sends it to archive if exists and “*” (after “8”) restart recording.
[405] “2” key—Mark point of an existing self-created MII, indicating editing/masking/deletion point of last-heard MII-AMS combination, where second press of “2” activates MII masking, “2”+“*” cancels masking and “2”+“5” deletes MII from file, and “2”+“0” starts editing of the existing AIP.
(In general [405] “2” key used for function related to inserting new marked “Marked Information Items” (MIIs), and related links to an archive).
[408] “7”, [423] “9” keys—Software programmable keys (based on required commands).
[411] Microphone—Voice commands input port (using IVR—Interactive Voice Response).

According to one embodiment of the current invention, the user may use the I/O ports of the mobile communication device as a hand held “remote controller” to interactively manage the information flow and to activate related linked processes. The interactive control is described in details by the following step-by-step operation processes, used for search for, find and activate links to MII within an audio/audiovisual information file:
Switch on the mobile communication device by ON/OFF switch [412].
If listening to the MII containing files is conducted using the mobile device, connect to information site using communication device input ports, preferably using pre-set “quick-dial” mode single-click dialing, or preset entries at the mobile-device “phone-book”, pass security check if applicable, and listen to the streamed or played files via [402] (or earphone). Otherwise, switch on the alternative device used for streaming/playing the relevant file and listen to the data keeping the mobile device ready for interactive session.
1)—If listening to the files using the mobile phone, and when required:
a)—use [414] “5” key—to Start/Stop the Played MII-containing file and also, when required, use [415] “6” key—FF (Fast Forward) or use [407] “4” key—FB—Fast Backwards, for fast search of items in the streamed/played file.
b)—Upon hearing MII and related AMS and if interested in relevant AIP, press [413] “#4” key to activate the relevant link for retrieving related information or activating linked process.
c)—Listen, or listen and watch the said retrieved related data and use [414] [415] [407] “4”, “5”, and “6” to browse for MIIs included in the file or respond to the system authorization audio-notes when user is not preauthorized and authorization is obtainable.
d)—As before, upon hearing MIIs and related AMS select other AIPs by pressing [413] “#” key, or press [409] “*” key to go back to the previous information file entry point.
2)—If listening to the files using a device other than the mobile phone—
a)—Upon hearing an AMS related to an MII and if interested in the AIP, connect to the information site, related to the file source, using, preferably using prompt dialing options such as “quick-dial” or out of “phone-book” dialing,
b)—If no security check is required and no ambiguity exist regarding the currently played/streamed file, the log-in to the relevant information site is equivalent to activating the AIP. If AIP is directed to the mobile device continue with 1) c) above. If AIP is directed to a different device, use AIP upon operating relevant device.
c)—If security check required upon logging into the information site or ambiguity exists with regard to the requested AIP, complete log-in with identifying yourself and identifying the AIP, per information site prompt protocol and continue as in b) above.

Adding online user-created AIPs to an audio-based file:
While streaming/playing an audio-based information file, use [414] [415] [407] “4”, “5”, and “6” to search and locate the information item to be marked.
Press [410] “0” key to point at MII and indicate insertion point of related AMS. Wait for system's authorization tone and follow audio-based authorization process if required. Key “0” again to start cyclical playing of alternative AMS types and when applicable their commonly agreed “library-meaning”. Select AMS by the “#” key and use “#” to confirm or “*” to go back to AMS list. Follow audio instruction to record user's attached comment and when ready press “8” to start recording. When done, press “5” to Stop recording (5=Stop/Play) or to replay AIP and “#” to send AIP to archive or “*” to restart recording process.
Use [414] [415] [407] “4”, “5”, and “6” to replay all on the new AMS combinations and the linked recorded message. Follow instructions to modify the information.
Always use [409] “*” key—to go back to the last entry point.

For example, editing or deleting existing MIIs and their related links out of an MII-containing file or a related archive may be conducted as follow:
While playing an information content file, use [414] [415] [407] to search and locate the existing MII to be edited or deleted.
   Press [405] “2” key upon hearing the relevant AMS to point at the existing MII to be edited/deleted. Wait for system's authorization tone or authorization instructions when user is not preauthorized to conduct editing/deleting of MIIs. Once authorization obtained, use the “0” key to start editing (marking MII), or “2” (again) for masking the current AMS or “5” to delete the current MII-AMS combination from file. If “2” or “5” are pressed at this stage, the system will require final confirmation by “#”. If “0” is pressed, the system will start editing process by automatically present the existing AMS, and will wait for press “#” to confirm or “*” to go back for AMS selection out of AMS list. Once AMS confirmed the system will automatically play the current default AIP as recorded in files. At this point the user can select between selecting alternative AIP connected to the MII using the “5” key (AIPs will be presented cyclically and user will select using the “#” key), or a complete new recording of the default/selected AIP using “8” and then following the recording process as described above, or adding/deleting a voice segment to/from the current AIP by indicating the insertion point using “0” and then recording the new voice segment following the process described above or deleting the remainder of the AIP by pressing “5”.
Use [409] “*” key—to go back to the last entry point.

For example, locating and activating an archived MII and its related links and AIPs may be conducted as follow:
Switching on the Mobile communication device by ON/OFF switch [412].
Access data information site using the communication device input ports to log into the “portal” where an audio based information site allows access to previously archived MII files.
Listen via [402] (or earphone) to audio or audiovisual-based archived information flow.
While playing the archived information content file, use [414] [415] [407] to search and locate the required archived MII-AMS combination and its linked AIPs. If short description (“abstract”) of relevant AIPs linked to a certain combination is available use the “3” key to first receive the relevant MII-AMS combination and then press the “3” again to retrieve the required “abstract” of the related AIPs. Once a specific MII-AMS and related AIP are selected, activating the link to the AIP is accomplished by—
pressing [413] “#” key—which connects the user to the default AIP. If more than a single AIP are available for activation by the user, and the first press of “#” is not connected to the “abstract” streaming, the system will present the available AIPs headers, and the user will select the required one either by pressing “#” after hearing the “header” name or by pressing the AIP number within the heard list. When user is not preauthorized to activate certain AIP and such authorization is obtainable, follow authorization process as directed by the system.
Use [409] “*” key to go back to the last entry point in the archive file.

An example of activating a process of connecting to communication network nodes:
Switch on the mobile communication device by ON/OFF switch [412].
Access data information site using the communication device input ports to log into “portal” where an audio-based information site allows access to previously archived file.
Listen via [402] (or earphone) to audio or audiovisual based archived information flow.
Use [4061 “1” key to connect (or disconnect) to (from) voice communication link enabling an initiation of voice or voice-over-IP related connection to call-center or other audio based networks as instructed by streamed/played audio-file.
While connecting via the system-soft switch to the communication network use the mobile communication keys such as [404] “joy-stick” and [417] “Enter” to operate the mobile device and the connected communication network functionality.
Switch-off the call to terminate connection link, or use [409] “*” key to return to the MII-containing information file entry point.

In a different embodiment of the current invention, the methods for audio-marking of information items (MIIs) for identifying and activating links to additional information or processes (AIPs) related to the marked items can be applied to expanding existing current art IVR (Interactive Voice Response) based systems while avoiding a direct change of the internal architecture of an existing IVR menu-tree architecture. The current IVR based systems are commonly designed with hierarchical multi-level, menu-tree architecture in which users usually access the menu-tree through its top level and by selected the optimal option at each branching junction, they move between the menu-levels until reaching the required information or process they search for.

According to the current invention, the current art IVR menu-tree architecture can be expanded through marking specific information items (MIIs) by AMSs and enabling connection to related AIPs, thus allowing retrieval of additional linked information or processes from alternatively-linked sources, or generating short-cuts between branching junctions of the existing menu-tree, while avoiding changes of the existing IVR tree logic. Furthermore, since the insertions of MIIs together with related AMSs, AIPs, and relevant activation rules are based on authorization rules, defined by the MIIs creators or editors, the IVR architecture can be easily personalized for specific users or user-groups without any change of the common basic logic of the IVR-processes. Thus, the expanded version of the original, PRE-CHANGED IVR logic can present personalized short-cuts of the common menu-tree or introduction of new information items or processes that are relevant for a restricted group of users only.

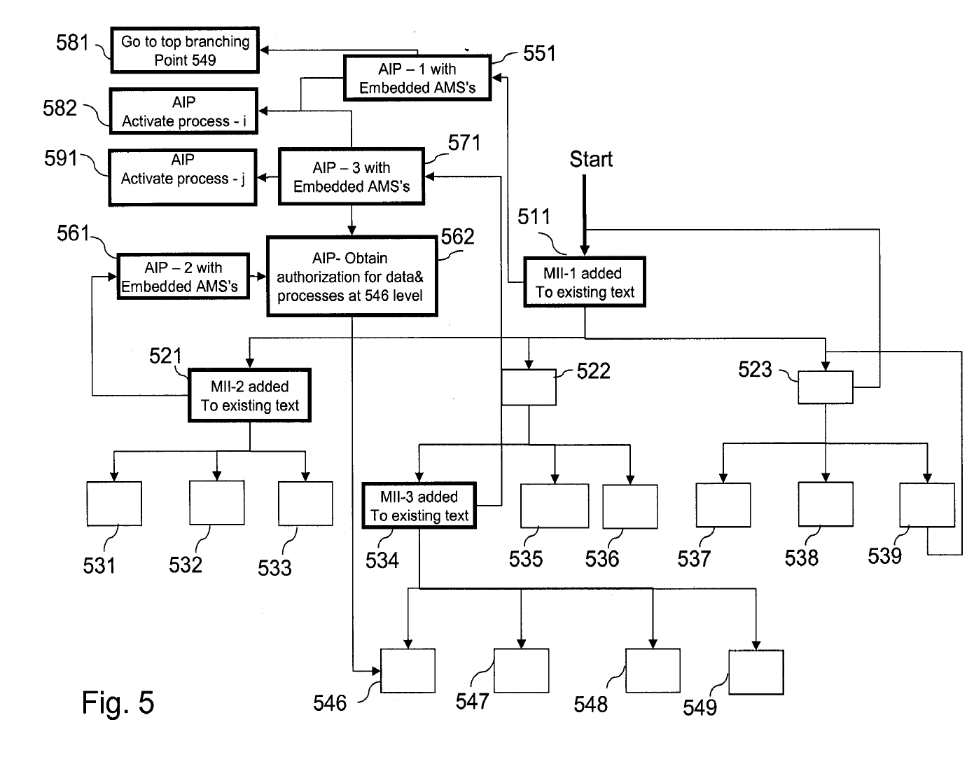

FIG. 5 describes an example of the existing art utilized for constructing an IVR menu-tree, marked by numbers between 511 and 549. A common user usually enters the menu at its top level [511] and starts searching for the required information items or processes by selecting between options which are presented audibly at each tree-level. Thus, a common user can select while being at [511] between the options [521], [522] or [523]. If one is selected, say [522], the next branching option is opened to select between—[534], [5351 and [536]. Such branching while searching for the “end target” can continue, if for example the selected option is [534], which opens audio-options [546], [547], [548] and [549] to authorized users.

The common architecture of a standard menu-tree restricts the number of links between lower-level branches of the tree connected to different main branches. Thus, for example, if a user decides to re-select a major branch other then one selected at [511], the system must receive a “go-back” command and the “back” options usually consist of limited alternatives such as: “back to the former junction point”, “back to the top of the menu” or “back to a ‘help’ junction”. In our case, for example, a user at [539] wishing to move to, for example, the [54X] level of the tree needs to go back twice (from [539] to [523] and then to [511]), or if applicable jump by a single command back to [511] and then starts the process again by three successive selection commands. Such logic, even though enabling a guided direction of a user to any information item required, may be found extremely tedious when the user needs to go through many branching points in search for the required information.

The other modules included in FIG. 5, marked by numbers higher than [5501, show by examples the benefits gained by introducing the MIIs and related AMSs, AIPs and relevant activation rules for expanding the IVR system without changing its original common logic. For understanding the value of such expansion, and without affecting its generality, let's examine several examples, embedded within the FIG. 5.

### EXAMPLE 1

A user, while being at certain IVR-level, [511] in this case, hearing the guideline to select between the next level options, can hear an AMS, related to a certain MII-1, enabling prompt linking by an activation command (“#” according to FIG. 4, or by using any other input port assigned for such a task) to AIP-1 which can expand the details presented to said specific user. AIP-1 can then be used, through its internal MIIs and AMSs, for either selecting a direct jump (by selecting the AIP related to [5811) to menu-tree element [549] or activation of process-i (by selecting the AIP related to [582]). The MII, AMS, AIP insertion does not affect the original logic enabling a user, for example to reach [549] by the serial selection of [522], [534] and then [549], and yet, it expands the data required for decision making and can add processes that may be relevant for a restricted group of users (like process-i), without introducing this branching option to irrelevant users.

### EXAMPLE 2

A user, while selecting relevant options at [511], reaches [521] since the common logic requires the user to be preauthorized for entering main branch [522]. Under certain circumstances the required authorization for using [522] is obtainable but users should be exposed to the relevant data. By adding the relevant details while introducing [521] and marking certain authorization request as MII-2, the user can select relevant link, presented as AIP-2 at [561] using relevant activation command (“#” according to FIG. 4, or by using any other input port assigned for such a task), upon hearing the relevant AMS-2, and while hearing the authorization requirements at [561], selecting the AIP which acts as the authorization process at [562] leading the process directly to branching point [546].

### EXAMPLE 3

A user authorized to enter branch [522] selects an option [534] to hear that not all of options [54X] are available for activation, but further clarification can be retrieved through AIP-3 connected to MII-3 presented by AMS-3. By activating AIP-3 at [571], (using “#” according to FIG. 4, or by using any other input port assigned for such a task) upon hearing the AMS related to MII-3, the user can receive the relevant personalized details and using the embedded MIIs-AMSs combinations embedded in AIP-3 the user can select between several alternatives such as, for example, activate the AIP presented at [562] described before for reaching [546] or select alternative processes such as processes—i=([582]) or j=([591]).

All the above examples include an option, during activation of the relevant AIPs, of sending the “back” control command, leading eventually to a return to the original IVR branching point within which the relevant MII was marked and the relevant AIPs were activated, enabling smooth return to operating the original IVR logic.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
a) marking information items within data files by coupling selected Audio, Audiovisual or Audio Sensual Marking-Signals (AMSs) with a Marked Information Item (MII), targeted at notifying users and programs about additional accessible information or processes (AIPs) related to the MII, and where the AMSs are programmed as one of the groups consisting of:
i) embedded signals, superimposed within streamed or file-transferred audio or audio-visual data;
ii) externally generated signals, which are on-line synchronized with the audio or audio-visual streaming or playing of the data containing the MII;
iii) internally generated by a device receiving the MII containing file in response to an AMS trigger;
b) defining, storing, and enable retrieving of:
i) MII and its related characteristics together with:
ii) the types and content of AMSs coupled to the MII;
iii) the types and content of AIPs coupled to the MII;
iv) the links to access and activate AIPs related to the MII; and
v) the activation and authorization rules related to an AIP activation.

2. The method of claim 1 further comprising methods for enabling:
a) activating selected AMSs while streaming or playing the MIIs containing data for signaling users and programs about an existence of identified and accessible links to AIPs that are related to said MIIs and are accessible to and usable by authorized receiving entities;
b) receiving activation commands, sent by users or programs, utilizing communicating devices and usable communication infrastructure;
c) verifying, and then accepting or rejecting activation commands in accordance with method's activation and authorization rules, correlated with detectable identifiers and data which are extractable from the said received command; and
d) activating the requested processes and distributing the additional requested information, in accordance with activation and authorization rules and said extractable identifiers and data embedded in the activation commands, combined with user's or program's characteristics, if accessible to the method operator.

3. The method of claim 1 further comprising a series of processes which are utilized for creation or editing of a marked information item, linked to additional information or processes:
a) selecting at least one marked information item (MII) to be marked by a marking signal;
b) defining at least one additional accessible information or process (AIP) related to the at least one information item, said defining including at least one AIP characteristic selected from the group consisting of: i) locations where such AIPs are stored, ii) a means to access or activate such AIPs and, iii) authorizations required to access the AIP;
c) selecting at least one type of Audio marking signal (AMS) to be used for marking at least one MII;
d) combining AMSs with MIIs to enable synchronous onset of the AMSs with related MIIs, enabling users to identify the MIIs through receiving the AMSs;
e) defining and storing retrievable relations between the created or edited MII and related at least one AMS, at least one AIP, the links to access and activate the AIPs, and other MII characteristics such as related activation and authorization rules, and at least one activation command set for activating the at least one AIP or to search for stored MII or its related entities;
f) defining rules of utilizing activation commands to be generated by an authorized user or a program, to be used upon receiving AMS, or while searching the MII related archive, for accessing at least one of AIPs related to at least one of MIIs;
g) online managing data distribution and process activation through:
i) transmitting a selected AMS in correlation with a selected MII, to selected potential recipients exposed to data containing the selected MII;
ii) receiving and decoding activation messages in correlation with transmittal of an MII-AMS combination for identifying a sender of a command, its relevant authorizations and requested related AIPs;
iii) verifying authorizations of requested receiver, to access or receive at least one requested AIPs;
iv) identifying authorized requested AIPs, and when required by process, personalize the data per requirements of authorized user or MII generator or editor or distributor;
v) enabling access of the relevant authorized users to the relevant AIPs including distribution of data through communication channels.

4. The method of claim 1, wherein said MII includes information selected from a group consisting of audio words, sentences, description of an object, expressions, names, a typical audio signal or string of audio-signals, story, song, recognizable specific persons' voices or tunes, head-lines, events, a general subject described in a played audio or an audio-visual clip, or hidden information item embedded in the data file, wherein said hidden relates to its limited exposure to users who should not be exposed to the MII.

5. The method of claim 1, wherein accessible links to related information or processes can be further retrieved or activated by submitting activation commands of said links, containing extractable data in accordance with at least one of a group consisting of: i) temporal-correlation with said AMS, ii) an AMS identifier, iii) an MII identifier, iv) an identifier of the data-file containing the MII; v) an identifier of the activation message sender, vi) an identifier of the requested receiver of the AIP.

6. The method of claim 1, wherein the accessible links to related information or processes can be further retrieved or activated by submitting activation commands of such links which can activate audio or audio-visual correlation between audio or audio-visual content related to the MII, said correlation is based on at least one of i) the MII content or ii) the AMS content or iii) content combining the AMS and its background, iv) content included or related to the MII containing file.

7. The method of claim 1, wherein the AMS comprises signals including at least one of an audio tone, an agreed audio expression, an audio background, audio or audio visual enhancements of the MII, a vibrating or audio-sensual signal, a signal combining components which are unheard or unseen by human bare ears or eyes, a voice signature typical to specific person(s), or a flashing light or audiovisual display, configured either as a single component signal or a train of several components, capable of being heard, or heard and seen, or sensed and recognized, by an authorized user or a program utilizing the streamed or played content, as an indication of links between the MII and additional retrievable information or additional linked processes (AIPs) that can be activated by submitting an activation command which can be correlated to the AMS-MII combination.

8. The method of claim 1, wherein the AMS either i) is super-imposed within the streamed or played data, or ii) generated externally to the device used for streaming or playing of the data, and wherein the AMS is activated in correlation with an onset of the MII, namely within a certain time-interval before, during, or after or any optional combination of before, during, and after the onset of the MII.

9. The method of claim 1, wherein said AMS is selected by at least one of the group consisting of: a) an MII creator or editor, utilizing a library of AMSS, offered to users by a service operator, b) an MII creator or editor, utilizing a library which is personalized by an individual user or a group of users, c) a user of the method wherein MIIs in a played file adopt specific AMSs based on specific user's preferences, priorities or other personalized selection, and wherein selected AMSs contain a variety of different audio or audio-visual or audio sensual signals, part of which can be linked to at least one of the group consisting of: i) certain combinations of MII and AIP types, ii) types of the links between MII and certain AIPs, iii) an identity of the MII creators and editors, said method iv) authorizations required for activating AIPs, v) financial parameters related to activating the AIP, vi) technical requirements related to the device receiving the AIP, further including the following step in conjunction with claim 1—a′) enabling generation of preset linkage between characteristics of different audio-components constructing the AMS and certain alternative types of attached links and certain alternative types of additional linked information or processes (AIPs), or other predefined parameters connected to links between the MII and AIPs such as a predefined MII creator, user or editor preferences, and AIPs activation costs and technical limitations.

10. The method of claim 1 wherein authorization criteria together with the activation rules of related AIPs are defined cumulatively by authorized entities including activation message senders, data-receiving entities, original MII creator, authorized MII editors, and service operators, and translated into at least one of the methods selected from the group consisting of: i) a denial of an activation command related to such AIPs sent by an unauthorized user, or sent not in accordance with the activation rules, ii) a audible message of the authorizations required and activation rules, played in accordance with the activation of MII-AMS combination, and iii) masking of relevant AMSs, related to AIPs that are either one of unauthorized for or inaccessible to or pre-rejected by a user or a program, while playing or streaming MII containing files to such users or programs.

11. The method of claim 1 wherein authorization can be granted to at least one of:
a) preauthorized list of identified users or programs, where identification is based on submission of either i) agreed pass-codes, or ii) usernames such as user selected name or the identity of the device used for submitting activation-commands, or for connection to AIPs or iii) a combination of pass-codes and usernames wherein a username can be an agreed name including the identity of the device sending the command or the device to which the AIP should be linked;
b) preauthorized members of specific user-groups, based on a user's affiliation to a specific group, which requires identification of user's affiliation with or without a requirement for an individual user identification;
c) users who are not preauthorized but allowed due to their characteristics or affiliation to obtain either temporary (time or event limited) or permanent authorization; and
d) entire user-base defined by geographical boundaries, or communication network coverage, or period of time, or participants of a certain event or a combination of part of these parameters.

12. The method of claim 1 wherein storing all or part of the relations between MII and related AMSs, AIPs, the links for accessing and activating relevant AIPs, MII creators and editors, and relevant activation and authorization rules, is designed to enable simplified methods for search& find MIIs or their related entities and then activate related AIPs, using their registered characteristics, based on search algorithms and parameters such as, but not limited to, the data files containing the MIIs, the MII type, the AMS used, the MII creator or editors, the type of AIPs, the type of links to AIPs, the required features of the devices used to activate the AIPs, wherein the search and find commands are submitted by an authorized user, utilizing a device including and not limited to, i) the device which is used to activate the AIPs and ii) the device which is used to receive the AIPs iii) a device which is used for search purposes.

13. The method of claim 1 further applied to complementing the current art IVR (Interactive Voice Response) menu-tree architecture based systems and methods, comprising at least one of the methods:
a) retrieval of additional linked information or processes from alternatively linked sources, being the AIPs, added by marking selected information items (MIIs) by AMSs in accordance with predefined set of activation and authorization rules;
b) creation of short-cuts between branching junctions of the said IVR based menu-tree, wherein the short-cut is the AIP and the new branching point is defined by an MII-AMS combination;
c) implementation of additional activation and authorization rules and authorization acquisition processes, wherein the authorization process is the AIP, marked by an MII-AMS combination in relevant branching point;
d) personalizing an IVR process for specific users or, user-groups through optimizing branching junctions using the MII, AMS, AIP linking.

14. An interactive communication system, configured to stream or play interactive audio and audio-visual content utilizing devices comprising:
a server or distributed computerized-entities based on devices functioning together as a distributed server;
a communication infrastructure used for linking system users with servers and computerized entities for enabling distributed server functionalities;
a set of instructions programmed into said server, and distributed computerized entities, said instructions comprising:
a) means for marking information items within data files by coupling selected Audio, Audiovisual or Audio Sensual Marking-Signals (AMSS) with a Marked Information Item (MII), targeted at notifying users and programs about additional accessible information or processes (AIPs) related to the MII, and where the AMSs are programmed as one of the groups consisting of:
i) embedded signals, superimposed within streamed or file-transferred audio or audio-visual data;
ii) externally generated signals, which are on-line synchronized with the audio or audio-visual streaming or playing of the data containing the MII;
iii) internally generated by a device receiving the MII containing file in response to an AMS trigger;
b) means for defining, storing and enable retrieving of:
i) MII and its related characteristics together with:
ii) the types and content of AMSs coupled to the MII;
iii) the types and content of AIPs coupled to the MII;
iv) the links to access and activate AIPs related to the MII; and
v) the activation and authorization rules related to an AIP activation.

15. The interactive communication system of claim 14 further comprising:
a) means for activating selected AMSs while streaming or playing the MIIs containing data for signaling users and programs about an existence of identified and accessible links to AIPs that are related to said MIIs and are accessible to and usable by authorized receiving entities;
b) means for receiving activation commands, sent by users or programs, utilizing communicating devices and usable communication infrastructure;
c) means for verifying, and then accepting or rejecting activation commands in accordance with method's activation and authorization rules, correlated with detectable identifiers and data which are extractable from the said received command, and;
d) means for activating the requested processes and distributing the additional requested information, in accordance with activation and authorization rules and said extractable identifiers and data embedded in the activation commands, combined with user's or program's characteristics, if accessible to the method operator.

16. The system of claim 14 wherein the a user or a program can sense the said AMS via the device output ports such as speaker, earphone, vibrator, display, light signals, data-ports, using at least one of the following communication alternatives: a) utilizing the device which is used for receiving the MII containing file through the same communication channel used to receive the said file, wherein the AMSs are superimposed within the played file, b) utilizing the device of a) and another system component transmitting synchronous AMS to a channel different than one used by the device for receiving the MII containing file, c) utilizing a synchronized device for receiving the AMSs, other than the one used to receive the said MII containing file, d) utilizing application embedded in the device used for receiving the MII containing file and AMS triggers linked to it and generating a synchronous AMS by the device, based on AMS timing and type as defined by the trigger.

17. The devices of claim 14, used for at least one of:
a) receiving streamed or playing stored audio or audiovisual content containing MIIs and related AMSs or AMS-trigger to be translated to AMS by the device;
b) activating links to AIPs, in response to exposure to MIIs-AMS combinations;
c) linking to AIPs in response to approving activation commands by the server;
d) receiving the outcome of an activated AIP;
e) search and retrieve MIIs and later activate related AIPs by manipulating system's archive;
f) create, edit and archive MII's within a given data file, wherein managing the above tasks is based on at least one of means supported by the existing functionality, I/O ports and memory of the device—i) the device's preset memory, accessible to users, coupled with its standard “call” or “send” command, ii) DTMF (Dual-Tone Multi-Frequency) functionality of the device, iii) IVR (Interactive Voice Response) functionality of the device and the server, iv) Internet protocol communication instructions, and iv) Proprietary application imported from the system and operated using the device's operating system.

18. The system of claim 14, wherein said devices are programmed to become a computerized-entity handling part of the server functionality, in a distributed server configuration, utilizing application software activated by the device or by a remote server, for managing at least one function out of the following group using:
a) means for managing authorizations prior to sending activation commands by a device user or program;
b) means for personalizing user's AMS library as kept either within device memory or at remote memory;
c) means for generating/Masking AMSs by internal device procedure, synchronized with signals from streamed/played data file;
d) means for creating MIIs and related AMSs and AIPs within files to be stored within at list one of: i) devices memory, ii) other sites that are linkable utilizing communication infrastructure;
e) means for managing the archiving of MIIs and their related AMSs, AIPs, links to AIPs and related activation and authorization rules, within at least one of: i) devices memory, ii) other sites that are linkable utilizing communication infrastructure;
f) means for receiving and verifying activation commands related to AIPs stored within at least one of: i) the device memory ii) a remote memory;
g) means for activating AIPs in response to authorized activation command, said AIP is store in at least one of: i) the device memory ii) a remote memory.

19. The system of claim 14 further comprising transmission of activation commands through a server to information sites, wherein the commands originate from one of: a) a communicating device used to receive the MII containing files, b) a communicating device pre-authorized by the system but not identical to the one used to receive the MII containing files, c) a non-preauthorized communication device enabling transmission of activation commands ones its user or program obtained authorization by the system, wherein said commands are delivered through at least one of the following alternatives—i) national or regional wireless networks supporting end-to-end communication between a mobile device and activation-commands-receiver site, such as, but not limited to cellular, one or two-way messaging, regional/municipal Wi-Fi, WiMax, ii) local wireless link such as Blue-Tooth, IRDA or Wi-Fi networks for connecting the user's device and an activation-command-receivers through local link utilizing local communicating device connected to a wireless or wire-line computer networking system, iii) wire-line communication network connecting the command source and command receiver, such as conventional telephony system, LAN/WAN configuration, Cable TV network iv) web-based transmission wherein the command sender logs into the service-provider site for sending the activation commands.

20. The communication system of claim 14 wherein the information containing the MII and AMS combinations is transmitted to a group of information recipients through channels that do not necessarily support two-way communication, such as, but not limited to:
a) broadcasting through radio or TV channels;
b) broadcasting or multicasting or uni-casting utilizing at least one of: the internet infrastructure, Governmental information distribution channels, local advertisement media, Intranets;
c) broadcasting and multi-casting to a group of recipients within a well-defined geographical or network boundaries, such as, but not limited to recipients within theatres, business-campuses, work-groups, stadiums, schools, hospitals, limited urban districts, internet based chats or conferences, wherein the activation commands for linking the AIPs to recipients, are submitted to a the server using devices other than the ones used for receiving the MIIs-AMSs combinations, and wherein the system identifies the requested AIPs by a correlation check that includes at least one of the following means: i) timing correlation of the activation command and the transmitted AMS-MII combination ii) identifiers that are extractable from the activation command, iii) pieces of content related to at least one of the MII, the AMS, and the MII-containing file, transmitted by the user of the system to the server or submitted by a program on the receiving device, iv) verification dialogue managed between the activation command sender servers, and, wherein the system includes means that enables it to link default AIPs to the relevant devices of recipients who cannot be categorized by the system, and, when the AIP activators can be categorized, the system includes means to link personalized AIPs to relevant receiving devices.

21. The system of claim 14 further comprising an archiving subsystem and archive search and retrieve algorithms that include at least one of:
a) means for storing and retrieving all or part of relations between the AMSs, MIIs, MII type, transferred file information containing the MIIs, location of the MIIs within such information, links to retrievable AIPs, location and types of such related AIPS, a creator or editor of MII-AMS-AIP combination, activation and authorization rules related to each AIP;
b) means for enabling authorized users or a program access to data stored in such archives without a need to play or stream all of the MII containing files;
c) means for enabling authorized user or program to activate search queries, retrieve search results and activate retrieved AIPs;
d) means for enabling an authorized user or a program to extract the archived data using a simple predefined activation command sent by an authorized communication device or a program;
e) means for enabling an authorized user to import part or all of the archive into at least one communicating device and to manipulate the archive without requiring the support of the server; and
f) means for enabling an authorized user to import the necessary parts of the archive software into at least one communicating device, enabling the user to manage a personalized archive.
